(19) United States
(12) Patent Application Publication
(10) Pub. No.: US 2018/0157533 A1
(43) Pub. Date: Jun. 7, 2018

(54) APPARATUS AND METHOD TO ALLOCATE A JOB TO PLURAL NODES COUPLED TO EACH OTHER VIA A MESH OR TORUS CONNECTION

(71) Applicant: FUJITSU LIMITED, Kawasaki-shi (JP)

(72) Inventor: Tomoya ADACHI, Kawasaki (JP)

(73) Assignee: FUJITSU LIMITED, Kawasaki-shi (JP)

(21) Appl. No.: 15/817,957

(22) Filed: Nov. 20, 2017

(30) Foreign Application Priority Data
Dec. 1, 2016 (JP) 2016-234405

(51) Int. Cl. G06F 9/50

(52) U.S. Cl. CPC G06F 9/5027; G06F 2209/503; G06F 9/5072

(57) ABSTRACT

An apparatus allocates a job to nodes in a parallel processing system in which the nodes are coupled to each other via a mesh connection or a torus connection. The apparatus generates, for each region in an n-dimensional space representing connection relations among the nodes, available-node information indicating whether each node in a node group corresponding the region is available for executing the job, where n is an integer greater than 1, and a size of each region in each axis-direction other than a predetermined axis-direction in the n-dimensional space is a power of a predetermined integer greater than 1. Upon receiving an execution request of the job including a designated size in each axis-direction, the apparatus selects the available-node information in accordance with the designated sizes, and determines a target node to which the job is to be allocated, based on the selected available-node information.

### CROSS-REFERENCE TO RELATED APPLICATION

This application is based upon and claims the benefit of priority of the prior Japanese Patent Application No. 2016-234405, filed on Dec. 1, 2016, the entire contents of which are incorporated herein by reference.

### FIELD

The embodiments discussed herein are related to apparatus and method to allocate a job to plural nodes coupled to each other via a mesh or torus connection.

### BACKGROUND

Parallel processing apparatuses that perform a large scale of calculations are currently utilized. For example, in the parallel processing apparatuses, multiple nodes that execute calculations may be mutually coupled, and perform the calculations in parallel. A grid network is one of the topologies of the inter-connection among the nodes in the parallel processing apparatus. The grid network may be configured such that a pair of nodes execute a job through communication while another pair of nodes execute another job through communication in parallel. In this case, the use of the same inter-node link by the two communications may result in lowering in the computation performance. Accordingly, the job during the execution may adversely affect the execution of another job in some cases.

Therefore, there is a proposal in which a sub-grid that is a part of the entire grid is exclusively used by one job. In this proposal, a job management device prepares a bit string including bits each associated with one of nodes, and makes a value of each bit to indicate whether a job is allocated or not allocated to the node associated with the bit, thereby managing the allocation states of jobs to the nodes.

Related techniques are disclosed in International Publication Pamphlet No. WO 2012/020474 and Japanese Laid-open Patent Publication No. 2015-41302.

### SUMMARY

According to an aspect of the invention, an apparatus includes a plurality of nodes coupled to each other via a mesh connection or a torus connection. The apparatus allocates a job to the plurality of nodes. At start and end of execution of the job, the apparatus generates, for each of regions in an n-dimensional space representing a connection relation among the plurality of the nodes, available node information indicating whether each of a group of nodes corresponding the region is available for execution of the job, where n is an integer of 2 or more, and a size in a direction of each axis in the n-dimensional space other than a predetermined axis is a power of a predetermined integer of 2 or more. Upon reception of an execution request of the job including a designated size in a direction of each axis, the apparatus selects the available node information in accordance with the designated size, and determining a target node to which the job is to be allocated, based on the selected available node information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a parallel processing apparatus, according to an embodiment;

FIG. 2 is a diagram illustrating an example of a parallel processing system, according to an embodiment;

FIG. 3 is a diagram illustrating an example of a hardware configuration of a control node, according to an embodiment;

FIG. 4 is a diagram illustrating an example of a hardware configuration of a calculation node, according to an embodiment;

FIG. 5 is a diagram illustrating an example of calculation nodes coupled via a three-dimensional mesh network, according to an embodiment;

FIGS. 6A and 6B are diagrams each illustrating an example of calculation nodes coupled via a torus network, according to an embodiment;

FIG. 7 is a diagram illustrating an example of a functional configuration of a control node, according to an embodiment;

FIGS. 8A and 8B are diagrams illustrating an example of a table indicating an availability of calculation nodes, according to an embodiment;

FIG. 9 is a diagram illustrating an example of an operational flowchart for available node information generation, according to an embodiment;

FIG. 10 is a diagram illustrating an example of an operational flowchart for job allocation, according to an embodiment;

FIGS. 11A and 11B are diagrams illustrating an example of searching for available nodes, according to an embodiment;

FIG. 12 is a diagram illustrating an example of an operational flowchart for bit string determination, according to an embodiment;

FIG. 13 is a diagram illustrating an example of bit string determination, according to an embodiment;

FIG. 14 a diagram illustrating an example of the number of steps desired in relation to the number of calculation nodes, according to an embodiment;

FIG. 15 is a diagram illustrating a comparative example of functions of a control node;

FIG. 16 is a diagram illustrating a comparative example of an operational flowchart for job allocation;

FIG. 17 is a diagram illustrating a comparative example of an operational flowchart for allocation determination;

FIG. 18 is a diagram illustrating a comparative example of an operational flowchart for determination of base point coordinates;

FIG. 19 is a diagram illustrating a comparative example of an operational flowchart for job allocation;

FIG. 20 is a diagram illustrating a comparative example of an operational flowchart for allocation determination;

FIG. 21 is a diagram illustrating a comparative example of an operational flowchart for allocation determination using a retrieval mask;

FIG. 22 a diagram illustrating a comparative example of an operational flowchart for update determination of base point coordinates; and

FIG. 23 is a diagram illustrating an example of the number of steps desired in relation to the number of calculation nodes in comparison with the comparative examples, according to an embodiment.

### DESCRIPTION OF EMBODIMENTS

A delay related to selection of a node to which a job is to be allocated causes a problem in the parallel processing apparatus. The delay causes an increase in the waiting time until an inputted job is executed, and a lowering in the operating rate of all the nodes in a parallel calculation machine.

It is desirable to speed up the node selection in execution of a job.

Hereinafter, embodiments are described in details with reference to the drawings.

### First Embodiment

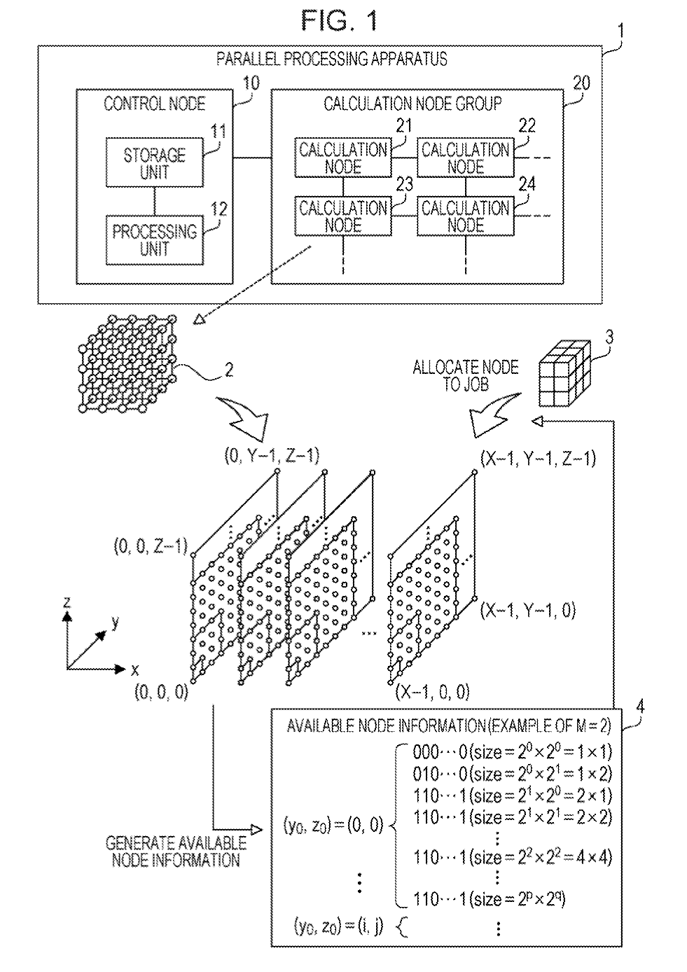

FIG. 1 is a diagram illustrating a parallel processing apparatus according to a first embodiment. A parallel processing apparatus 1 includes a control node 10 and a calculation node group 20. The control node 10 is coupled to respective calculation nodes in the calculation node group 20 via a predetermined network of the parallel processing apparatus 1. The control node 10 receives an input of a job. The control node 10 selects a calculation node where to allocate the job (such a node will be also simply referred to as an allocation node) among the multiple calculation nodes that belong to the calculation node group 20. The control node 10 causes the selected calculation node to execute the job. The size (the number or the shape of the calculation nodes to be allocated) of the calculation node used for the execution of the job is designated by a user, for example, when the job is received.

The calculation node group 20 includes calculation nodes 21, 22, 23, 24, . . . . Each of the calculation nodes 21, 22, 23, 24, . . . , includes a memory and a processor. The calculation nodes 21, 22, 23, 24, . . . , execute the job allocated by the control node 10. The calculation nodes 21, 22, 23, 24, . . . , are mutually coupled to form a network 2. The calculation nodes 21, 22, 23, 24, . . . , are mutually communicated via the network 2 to execute the job in parallel.

The network 2 is an n (n is an integer of 2 or more)-dimensional grid network. For example, the network 2 is a network of a connection form called a mesh connection or a torus connection. The network 2 in FIG. 1 is exemplified as a connection form of a three-dimensional (n=3) mesh connection. One grid point serves as one calculation node. One grid point is expressed by coordinates (combination of integers of 0 or more) in the space. The control node 10 allocates a sub-grid (subset of grid points) that is a part of the entire grid, to a job. One job exclusively uses the calculation nodes belonging to the sub-grid. When having already allocated a given job to a given calculation node, the control node 10 excludes the given calculation node from allocation candidates for another job.

The control node 10 associates one calculation node with one bit, and manages an availability (whether or not a job is allocated) of the associated calculation node, based on a value of the bit. For example, a bit value “1” indicates that job allocation is impossible (job has already been allocated or at fault), and a bit value “0” indicates that job allocation is possible (job is unallocated). The control node 10 provides a function to speed up selection of a calculation node where to allocate the job, by using the availabilities of calculation nodes expressed by such information.

The control node 10 includes a storage unit 11 and a processing unit 12. The storage unit 11 may preferably be a volatile storage device such as a random access memory (RAM), or may preferably be a nonvolatile storage device such as a hard disk drive (HDD) or a flash memory. The processing unit 12 may include a central processing unit (CPU), a digital signal processor (DSP), an application specific integrated circuit (ASIC), an field programmable gate array (FPGA), and others. The processing unit 12 may preferably be a processor that executes a program. The “processor” may include a set (multi-processor) of multiple processors.

For each of regions in the n-dimensional space indicating the connection relation among the calculation nodes 21, 22, 23, 24, . . . , whose size in a direction of each axis other than a predetermined axis is a power of a predetermined integer M of 2 or more, the storage unit 11 stores therein available node information on a calculation node group belonging to the region. The “region” includes a linear region. Moreover, the “region” may be referred to as “range”. Moreover, a power of the integer M (may also called an exponentiation of M) is a value expressed as M^{k} where the base is M and the exponent is k (k=0, 1, 2, . . . ). The size in a direction of each axis indicates the number of calculation nodes in the direction of the axis concerned. The upper limit of k is determined depending on the number of calculation nodes in a direction of each axis included in the parallel processing apparatus 1.

The processing unit 12 generates available node information 4 when execution of a job is started and the execution is ended, and stores the generated available node information 4 in the storage unit 11. Here, the available node information 4 is a string of bits each indicating whether a job is already allocated to the associated calculation node or calculation node group.

For example, when the network 2 is a three-dimensional mesh (n=3), an x-axis, a y-axis, and a z-axis that are orthogonal to one another may be considered. In the parallel processing apparatus 1, it is assumed that the number of calculation nodes in the x-axis direction is X, the number of calculation nodes in the y-axis direction is Y, and the number of calculation nodes in the z-axis direction is Z, in the three-dimensional mesh. Any of X, Y, and Z is a positive integer, and X≥Y≥Z is satisfied. The abovementioned predetermined axis is, for example, an axis having the maximum number of calculation nodes (in order to efficiently perform a computation of node selection indicated below). In this case, the abovementioned predetermined axis is the x-axis. Moreover, axes other than the x-axis are the y-axis and the z-axis. Note that, when coordinates of the first calculation node are set at (0, 0, 0), (X−1, Y−1, Z−1) is obtained as diagonal coordinates relative to the coordinates in the three-dimensional mesh.

As for the job allocation, when a job is allocated to a calculation node group in which the x coordinate is x₀, inclusive, to x₀+x, exclusive, the y coordinate is y₀, inclusive, to y₀+y, exclusive, and the z coordinate is z₀, inclusive, to z₀+z, exclusive, the coordinate point (x₀, y₀, z₀) is called a base point. In selection of a calculation node to which a job is to allocated, the coordinate point (x₀, y₀, z₀) may be called a base point candidate.

Here, as an example, a case of M=2 is considered. A power of 2 is 2⁰ , 2¹, 2², 2³, . . . . The processing unit 12 calculates in advance, in preparation for the job allocation, information (available node information) to be used in the job allocation. Specifically, the processing unit 12 identifies, with respect to all the coordinates as a base point candidate, all the regions whose size for each of directions of axes other than the x-axis is a power of 2 (1, 2, 4, 8, . . . ), and generates, for each x coordinate, a string of bits each of which is set at 0 when all the calculation nodes within the region corresponding to the bit are available, and otherwise set at 1.

As an example, coordinates of a number X of base point candidates, in which (y₀, z₀)=(0, 0) is satisfied, are considered. The processing unit 12 generates multiple bit strings (multiple pieces of available node information) for the number X of base point candidates. In other words, for each region that satisfies (size in the y-axis direction)×(size in the z-axis direction)=2^{P}×2^{q}, the processing unit 12 generates a bit string including X bits as a piece of available node information. Here, p will take all the integers of 0 or more satisfying 2^{p}≤Y, and q will take all the integers of 0 or more satisfying 2^{q}≤Z. In the bit string, the most significant bit corresponds to an x-coordinate whose value is 0, and the least significant bit corresponds to an x-coordinate whose value is X−1 (the same applies to the following explanation). The size in the y-axis direction indicates the number of calculation nodes in the y-axis direction. The size in the z-axis direction indicates the number of calculation nodes in the z-axis direction.

For example, for a region that satisfies (size in the y-axis direction)×(size in the z-axis direction)=2⁰×2⁰=1, the processing unit 12 generates a bit string of “000 . . . 0” including X bits.

For a region that satisfies (size in the y-axis direction)×(size in the z-axis direction)=2⁰×2¹=2, the processing unit 12 generates a bit string of “010 . . . 0” including X bits.

For a region that satisfies (size in the y-axis direction)×(size in the z-axis direction)=2¹×2⁰=2, the processing unit 12 generates a bit string of “110 . . . 1” including X bits.

For a region that satisfies (size in the y-axis direction)×(size in the z-axis direction)=2¹×2¹=4, the processing unit 12 generates a bit string of “110 . . . 1” including X bits.

For a region that satisfies (size in the y-axis direction)×(size in the z-axis direction)=2²×2²=16, the processing unit 12 generates a bit string of “110 . . . 1” including X bits.

The processing unit 12 also generates pieces of available node information for regions corresponding to other combinations of p and q, in the similar manner.

In this manner, the processing unit 12 generates a piece of available node information 4, for each combination of (y₀, z₀)=(i, j) (i is an integer of 0 or more and less than Y, and j is an integer of 0 or more and less than Z) and (p, q), and stores the generated pieces of available node information 4 in the storage unit 11.

When the processing unit 12 receives an execution request of a job 3 including a designated size of each axis direction, the processing unit 12 selects available node information in accordance with the designated size with reference to the storage unit 11. The processing unit 12 determines an allocation node of the requested job, based on the selected available node information.

For example, when the processing unit 12 receives an execution request of the job 3 having the designated size x×y×z on the x-axis, the y-axis, and the z-axis, the processing unit 12 selects available node information corresponding to the size in accordance with y×z, from the available node information 4. In other words, the processing unit 12 calculates the maximum p that satisfies 2^{p}≤y and the maximum q that satisfies 2^{q}≤z, and determines an allocation node of the requested job by using the available node information for the combination of the calculated (p, q). The processing unit 12 firstly extracts a position at which the calculation nodes in a size of y×z are available, based on the corresponding available node information, and next extracts a region where the calculation nodes in the size of y×z are continuously available, for a value range of x-coordinates whose size is x, in the x-axis direction from the coordinates of the position. The processing unit 12 may perform the extraction processing at high speed by using the acquired bit string as available node information. The processing unit 12 then allocates the requested job to a calculation node group belonging to the region.

In this manner, the processing unit 12 generates the available node information 4 at the start and end of execution of a job. When the processing unit 12 selects an allocation node of the job, the processing unit 12 may perform determination processing for only the size of a power of M, based on the available node information 4. For example, in a case of M=2 and Y=100, the processing unit 12 may preferably perform determination processing for available node information on seven different sizes (1, 2, 4, 8, 16, 32, and 64) as for the y-axis. In this manner, the available node information 4 on the region of a given rectangular parallelepiped shape (or super rectangular parallelepiped shape) is prepared for the respective axes other than a predetermined axis, thereby making it possible to speed up the node selection when the job is executed.

Moreover, speeding up the node selection in execution of the job may reduce the waiting time for execution of the job, and improve the operating rate of the respective calculation nodes in the parallel processing apparatus 1.

Note that, at the start and end of execution of a job, the processing unit 12 may update the entire available node information 4, or update only a portion concerning the calculation nodes whose use states are changed, in the available node information 4. Limiting the update portion may further speed up the generation of the available node information 4. Moreover, the processing unit 12 may allocate a job to calculation nodes by repeatedly using the available node information 4 as long as the use state of the calculation nodes is not changed.

In addition, although the three-dimensional mesh network is mainly exemplified in the abovementioned explanation, the network 2 may preferably be a two-dimensional or four or more-dimensional mesh network, or may preferably be a grid network in which at least one axis is a torus axis.

### Second Embodiment

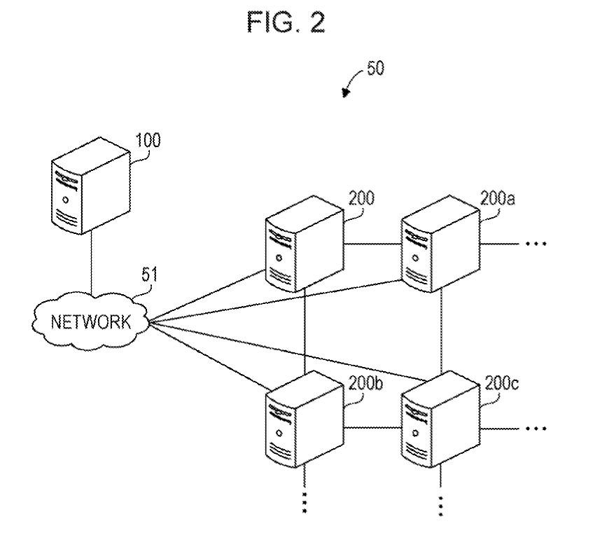

FIG. 2 is a diagram illustrating an example of a parallel processing system according to a second embodiment. A parallel processing system 50 includes a control node 100, and calculation nodes 200, 200a, 200b, 200c, . . . . The control node 100 and the calculation nodes 200, 200a, 200b, 200c, . . . are coupled to network 51 for management in the parallel processing system 50. Moreover, the calculation nodes 200, 200a, 200b, 200c, . . . are mutually coupled via a grid network.

The control node 100 receives an input of a job by a user, and allocates the job to the calculation nodes 200, 200a, 200b, 200c, . . . . Moreover, the control node 100 instructs calculation nodes as an allocation node to execute the job.

Each of the calculation nodes 200, 200a, 200b, 200c, . . . includes a processor and a memory, and executes the job allocated by the control node 100 in parallel.

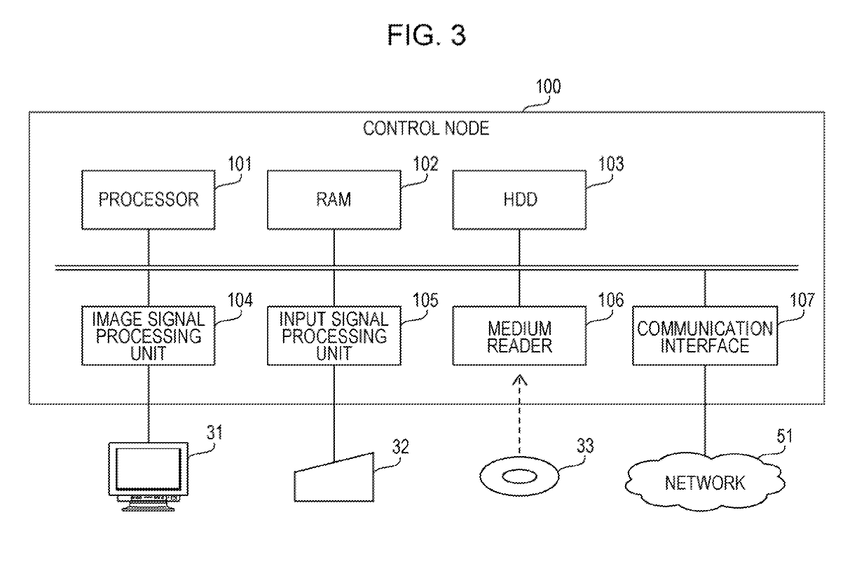

FIG. 3 is a diagram illustrating a hardware example of a control node. The control node 100 includes a processor 101, a RAM 102, an HDD 103, an image signal processing unit 104, an input signal processing unit 105, a medium reader 106, and a communication interface 107. These hardware units are connected to a bus of the control node 100.

The processor 101 is hardware that controls information processing of the control node 100. The processor 101 may be a multi-processor. The processor 101 is, for example, a CPU, a DSP, an ASIC, or an FPGA. The processor 101 may preferably be a combination of two or more elements among the CPU, the DSP, the ASIC, the FPGA, and other elements.

The RAM 102 is a main storage of the control node 100. The RAM 102 temporarily stores therein at least a part of programs of an operating system (OS) or application programs, which the processor 101 is caused to execute. Moreover, the RAM 102 stores therein various kinds of data used for the processing by the processor 101.

The HDD 103 is an auxiliary storage device of the control node 100. The HDD 103 magnetically reads data and writes data from and to a magnetic disk that is embedded therein. The HDD 103 stores therein programs of the OS, application programs, and various kinds of data. The control node 100 may preferably be provided with another type of an auxiliary storage device such as a flash memory or a solid state drive (SSD), or may preferably be provided with multiple auxiliary storage devices.

The image signal processing unit 104 outputs, in accordance with an instruction from the processor 101, an image on a display 31 that is coupled to the control node 100. As for the display 31, a cathode ray tube (CRT) display, a liquid crystal display, or other displays may be used.

The input signal processing unit 105 acquires an input signal from an input device 32 that is coupled to the control node 100, and outputs the input signal to the processor 101. As for the input device 32, for example, pointing devices such as a mouse and a touch panel, a key board, or other devices may be used.

The medium reader 106 is a device that reads a program or data recorded on a recording medium 33. As for the recording medium 33, for example, a magnetic disk such as a flexible disk (FD) or an HDD, an optical disc such as a compact disc (CD) or a digital versatile disc (DVD), or a Magneto-Optical disk (MO) may be used. Moreover, as for the recording medium 33, for example, a nonvolatile semiconductor memory such as a flash memory card also may be used. The medium reader 106 stores, for example, in accordance with an instruction from the processor 101, a program or data that is read from the recording medium 33, in the RAM 102 or the HDD 103.

The communication interface 107 is an interface that is coupled to the network 51, and is used for communication with each calculation node.

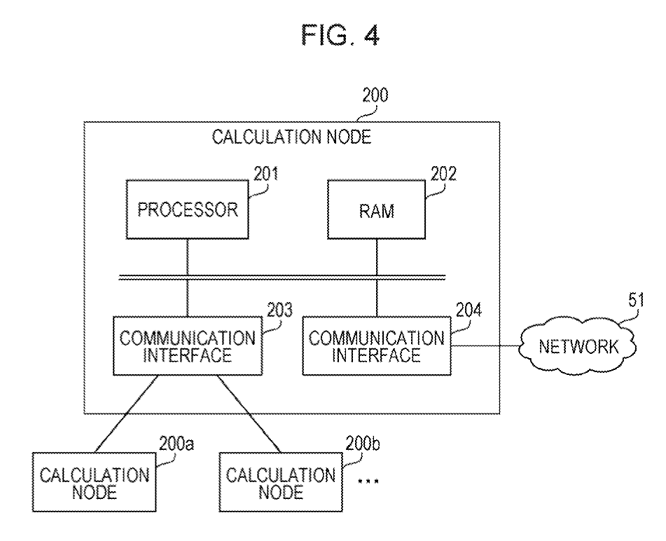

FIG. 4 is a diagram illustrating a hardware example of a calculation node. The calculation node 200 includes a processor 201, a RAM 202, and communication interfaces 203 and 204. These hardware units are coupled to a bus of the calculation node 200. The calculation nodes 200a, 200b, . . . may be also implemented using the hardware similar to that of the calculation node 200.

The processor 201 is a hardware that controls information processing of the calculation node 200. The processor 201 may preferably be a multi-processor. The processor 201 is, for example, a CPU, a DSP, an ASIC, or an FPGA. The processor 201 may preferably be a combination of two or more elements among the CPU, the DSP, the ASIC, the FPGA, and other elements.

The RAM 202 is a main storage of the calculation node 200. The RAM 202 temporarily stores therein at least a part of a program for executing the processor 201. The RAM 202 stores therein various kinds of data that are used for processing by the processor 201.

The communication interface 203 is an interface that is coupled to each of the calculation nodes 200a, 200b, . . . , and is used for communication with other calculation nodes.

The communication interface 204 is an interface that is coupled to the network 51, and is used for communication with the control node 100.

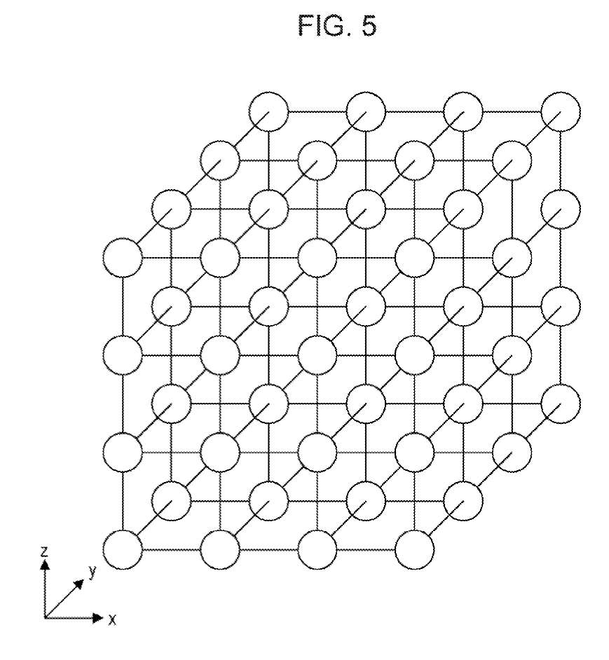

FIG. 5 is a diagram illustrating an example of calculation nodes coupled via a three-dimensional mesh network. In the example of FIG. 5, the number of calculation nodes (size) in each of the x-axis, the y-axis, and the z-axis directions is 4. One grid point represents one calculation node. A job shape is indicated by a rectangular parallelepiped in a three-dimensional mesh network.

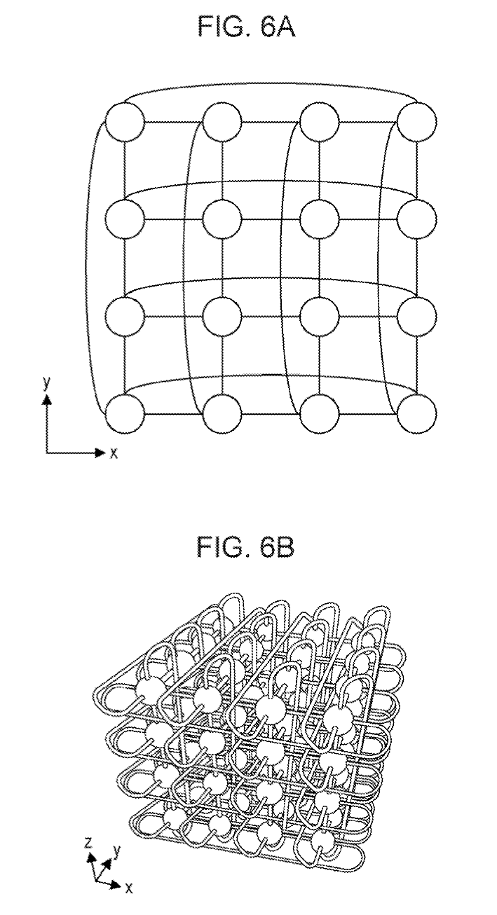

FIGS. 6A and 6B are diagrams each illustrating an example of calculation nodes coupled via a torus network. FIG. 6A illustrates the example of the calculation nodes coupled via the two-dimensional torus network. FIG. 6B illustrates the example of the calculation nodes coupled via the three-dimensional torus network. In the example of FIG. 6A, two axes of the x-axis and the y-axis are torus axes. Moreover, in the example of FIG. 6B, three axes of the x-axis, the y-axis, and the z-axis are torus axes. Further, only a part of all the axes that indicate the space may be a torus axis.

Here, in the parallel processing system 50, one job occupies a sub-grid relative to the entire grid. Accordingly, the sub-grid to which a given job has been already allocated is excluded from allocation candidates for another job.

In the following explanation, the function of the control node 100 is described by mainly assuming the three-dimensional grid network (three-dimensional mesh network or three-dimensional torus network). Further, the function of the control node 100 is applicable to the grid network not only of the three-dimension but also of another dimension.

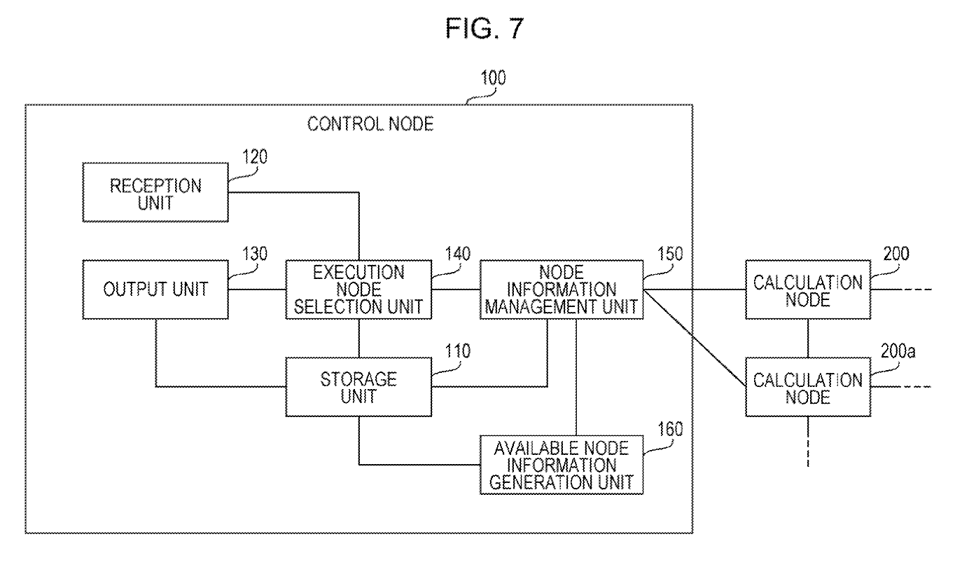

FIG. 7 is a diagram illustrating an example of a functional configuration of a control node. The control node 100 includes a storage unit 110, a reception unit 120, an output unit 130, an execution node selection unit 140, a node information management unit 150, and an available node information generation unit 160. The storage unit 110 is implemented using a memory area of the RAM 102 or the HDD 103. The reception unit 120, the output unit 130, the execution node selection unit 140, the node information management unit 150, and the available node information generation unit 160 are implemented in such a manner that the processor 101 executes a program stored in the RAM 102.

The storage unit 110 stores therein a table indicating an availability of a calculation node. One table corresponds to one bit string. The specific content of the table is described later.

The reception unit 120 receives an execution request of a job by a user. The execution request of a job includes the number of calculation nodes that is requested in the execution of the job, and information on the job shape (designated size). The job shape is a rectangular parallelepiped in a case of the three-dimension (for example, a rectangle in the two-dimension).

The output unit 130 causes the display 31 to display an allocation result of the job or an execution result of the job thereon. The execution node selection unit 140 selects (allocates a job to calculation nodes) calculation nodes that execute a job (execution node), based on the table stored in the storage unit 110. The execution node selection unit 140 instructs the calculation nodes as an allocation node to execute the job, via the node information management unit 150. Moreover, the execution node selection unit 140 provides an allocation result of the job to the calculation nodes or an execution result of the job, to the output unit 130.

Here, when a job is allocated to a group of calculation nodes in which the x-coordinate is x₀, inclusive, to x₀+x, exclusive, the y-coordinate is y₀, inclusive, to y₀+y, exclusive, and the z-coordinate is z₀, inclusive, to z₀+z, exclusive, the coordinate point (x₀, y₀, z₀) is called a base point. In determining calculation nodes as an allocation node of the job, the coordinate point (x₀, y₀, z₀) may be called a base point candidate. Further, in the following explanation, a base point candidate is also called a base point in some cases.

The node information management unit 150 manages a use state of each of the calculation nodes 200, 200a, . . . . For example, the node information management unit 150 generates allocation information indicating calculation nodes out of use which are not used in the job execution, calculation nodes that are in use for the job execution, and calculation nodes in trouble which are out of use but to which a job may not be allocated, and stores the allocation information in the storage unit 110. The allocation information is a bit map in which one calculation node is associated with one bit. As an example, in the bit map, 0 indicates out of use (job allocation is possible), and 1 indicates in use or in trouble (job allocation is impossible). The node information management unit 150 notifies the available node information generation unit 160 of the timing when the job has been allocated to the calculation node (the timing when the job execution is started) or the timing when the job has been ended.

The available node information generation unit 160 generates, based on the bit map stored in the storage unit 110, available node information (the abovementioned table), and stores the available node information in the storage unit 110. The available node information generation unit 160 generates a table at the timing when the job is allocated to the calculation node and at the timing when the job is ended (in other words, the timing when the use state of the calculation nodes is changed).

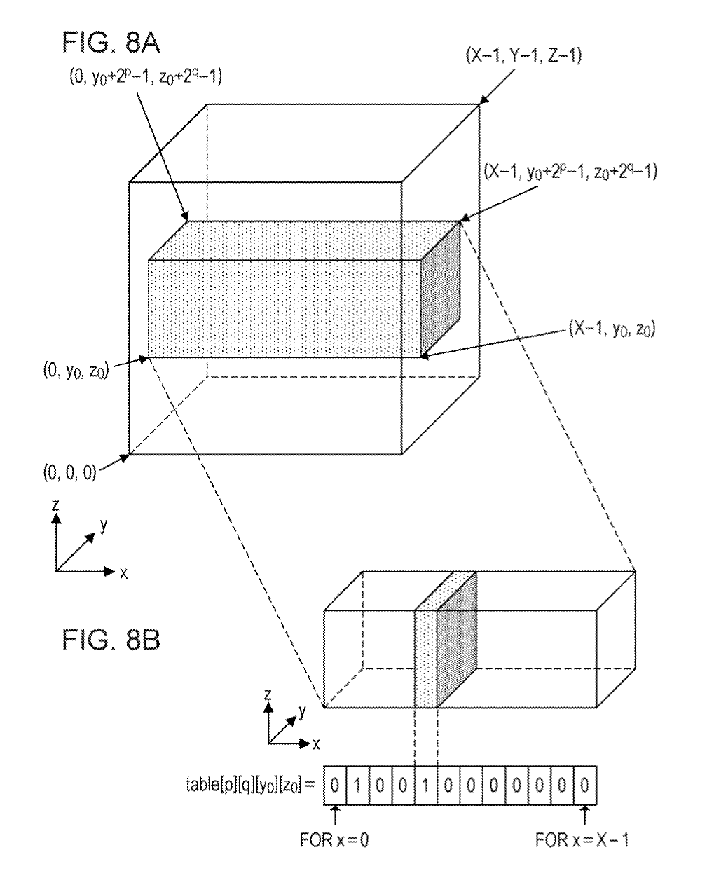

FIG. 8A and 8B are diagrams illustrating an example of a table indicating an availability of calculation nodes. Here, the number of calculation nodes in the x-axis direction is set at X, the number of calculation nodes in the y-axis direction is set at Y, and the number of calculation nodes in the z-axis direction is set at Z, which are included in the parallel processing system 50, where as described in the foregoing, X≥Y≥Z is established. The table is information of a bit string, and each bit in the bit string corresponds to an x coordinate. For example, out of the respective axes directions, an axis of a direction in which the number of calculation nodes becomes the maximum is set as the x-axis.

One table is identified by a combination of (p, q, y₀, z₀). FIG. 8A illustrates an example of a region for a table[p][q][y₀][z₀], where p is an integer that satisfies 2^{p}≤Y and is 0 or more, and q is an integer that satisfies 2^{q}≤Z and is 0 or more. In the example of FIG. 8A, a rectangular parallelepiped indicating a three-dimensional grid network is disposed in a space, including the origin point (0, 0, 0), in which the respective axes are positive. In this case, the coordinates (0, y₀, z₀) are coordinates of the base point by assuming that the job is allocated to all the calculation nodes belonging to a region for the table[p][q][y₀][z₀]. An example of apexes in a region for the table[p][q][y₀][z₀] are as follows. The coordinates at a position diagonally located from the base point position become (X−1, y₀+2^{p}−1, z₀+2^{q}−1). The coordinates at a position diagonally located from the same base point and on the yz plane become (0, y₀+2^{p}−1, z₀−2^{q}−1). The coordinates at an endpoint traveled from the same base point in the normal direction of the x-axis become (X−1, y₀, z₀).

FIG. 8B illustrates concepts of respective bits included in the bit string of the table[p][q][y₀][z₀]. FIG. 8B indicates an example of the case of X=12. For example, the case is the table[p][q][y₀][z₀]=010010000000. Each x coordinate is represented by 1 bit. In this case, the bit at the most significant digit is for x=0. The least significant digit bit is for x=X−1. For one given x coordinate, when the job allocation is possible to all the calculation nodes at all the coordinates that satisfy y coordinate being y₀, inclusive, to y₀+2^{p}, exclusive, and the z coordinate being z₀, inclusive, to z₀+2^{q}, exclusive, the bit for the x coordinate is set at 0. Otherwise (when the job allocation is impossible to at least one of the calculation nodes), the bit for the x coordinate is set at 1. Note that, the sizes in the y- and z-axes directions of a region for each table are not limited to a power of 2, but also may be a power of any integer of 3 or more.

In this manner, the available node information is indicated by a bit string (table) including multiple bits each corresponding to a coordinate value of a predetermined axis (for example, the x-axis). When job allocation is possible to all the calculation nodes belonging to a portion corresponding to a first coordinate value of a predetermined axis among the regions corresponding to the bit string, the available node information generation unit 160 sets a first bit corresponding to the first coordinate value at a first value (for example, 0) indicating that allocation of the job is possible. Meanwhile, when allocation of the job is impossible to at least one of the calculation nodes belonging to the portion, the available node information generation unit 160 sets the first bit at a second value (for example, 1) indicating that allocation of the job is impossible.

When the execution node selection unit 140 extracts allocation nodes of the job, the execution node selection unit 140 determines whether the bit string corresponding to the available node information includes a bit string portion in which the first value is continuously present in bits whose number corresponds to the designated size in the predetermined axis direction. When the bit string portion is present, the execution node selection unit 140 determines, as allocation nodes of the job, calculation nodes corresponding to the coordinate values (coordinate value range) of the bit string portion, among the calculation node group belonging to the region corresponding to the bit string.

Next, a procedure of processing by the control node 100 is described. Firstly, a procedure of processing by the available node information generation unit 160 is described.

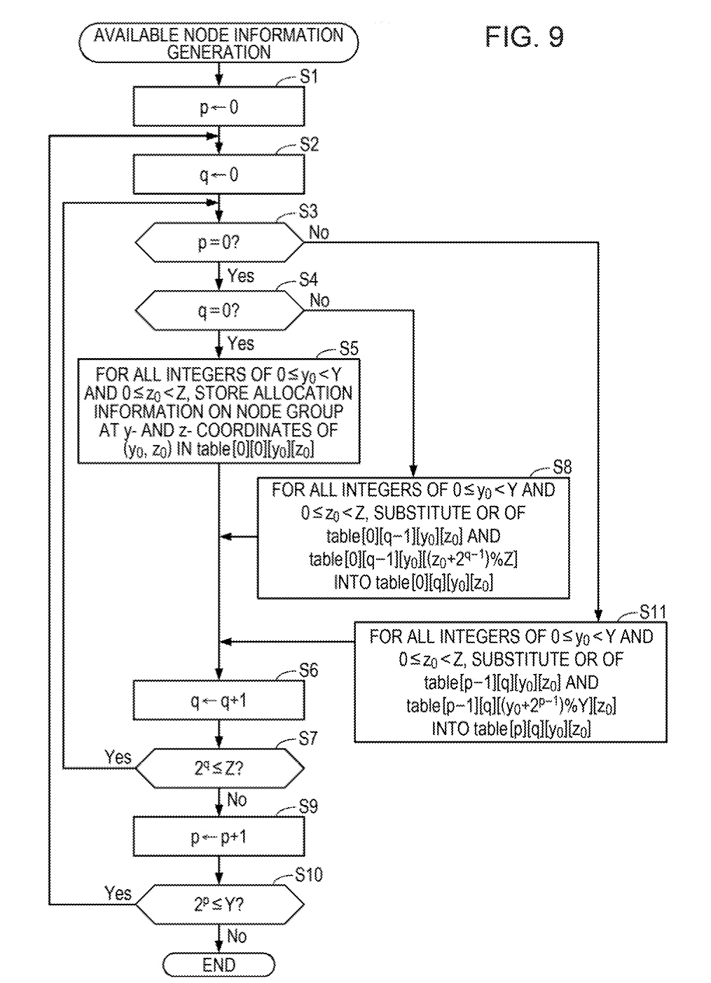

FIG. 9 is a flowchart illustrating an example of available node information generation. Hereinafter, the processing illustrated in FIG. 9 is described in the order of step numbers. When the available node information generation unit 160 receives the notification of the job having been allocated to the calculation node or the job execution being ended, from the node information management unit 150, the available node information generation unit 160 starts the following procedure.

(S1) The available node information generation unit 160 substitutes 0 into p.

(S2) The available node information generation unit 160 substitutes 0 into q.

(S3) The available node information generation unit 160 determines whether p=0 is established. When p=0 is established, the available node information generation unit 160 proceeds the processing to the step S4. When p=0 is not established, the available node information generation unit 160 proceeds the processing to the step S11.

(S4) The available node information generation unit 160 determines whether q=0 is established. When q=0 is established, the available node information generation unit 160 proceeds the processing to the step S5. When q=0 is not established, the available node information generation unit 160 proceeds the processing to the step S8.

(S5) The available node information generation unit 160 stores, for all the integers of y₀, z₀ (0≤y₀<Y, 0≤z₀<Z), allocation information for a node group whose y- and z-coordinates is (y₀, z₀), in the table[0][0][y₀][z₀] stored in the storage unit 110.

(S6) The available node information generation unit 160 substitutes q+1 into q.

(S7) The available node information generation unit 160 determines whether 2^{q}≤Z is established. When 2^{q}≤Z is established, the available node information generation unit 160 proceeds the processing to the step S3. When 2^{q}≤Z is not established, the available node information generation unit 160 proceeds the processing to the step S9.

(S8) The available node information generation unit 160 substitutes, for all the integers of y₀, z₀ (0≤y₀<Y, 0≤z₀<Z), OR (result of OR computation) of a table[0][q−1][y₀][z₀] and a table[0][q−1][y₀][(z₀+2^{q}−1)%Z] into the table[0][q][y₀][z₀]. Here, % sign indicates the remainder computation. The available node information generation unit 160 then proceeds the processing to the step S6.

(S9) The available node information generation unit 160 substitutes p+1 into p.

(S10) The available node information generation unit 160 determines whether 2^{p}≤Y is established. When 2^{p}≤Y is established, the available node information generation unit 160 proceeds the processing to the step S2. When 2^{p}≤Y is not established, the available node information generation unit 160 ends the processing.

(S11) The available node information generation unit 160 substitutes, for all the integers of y₀ and z₀ (0≤y₀<Y and 0≤z₀<Z), OR of a table[p−1][q][y₀][z₀] and a table[p−1][q][(y₀+2^{p}−1)%Y][z₀] into the table[p][q][y₀][z₀]. The available node information generation unit 160 then proceeds the processing to the step S6.

In this manner, the available node information generation unit 160 generates, in advance, tables [p][q][y₀][z₀] for all the combinations of (p, q, y₀, z₀), using the change in the use state of the calculation node as a trigger. The available node information generation unit 160 replaces the existing table with the newly generated table. Note that, the available node information generation unit 160 may preferably regenerate only the table related to the calculation nodes whose use state is changed, among the respective tables.

Next, a procedure of processing by the execution node selection unit 140 is described.

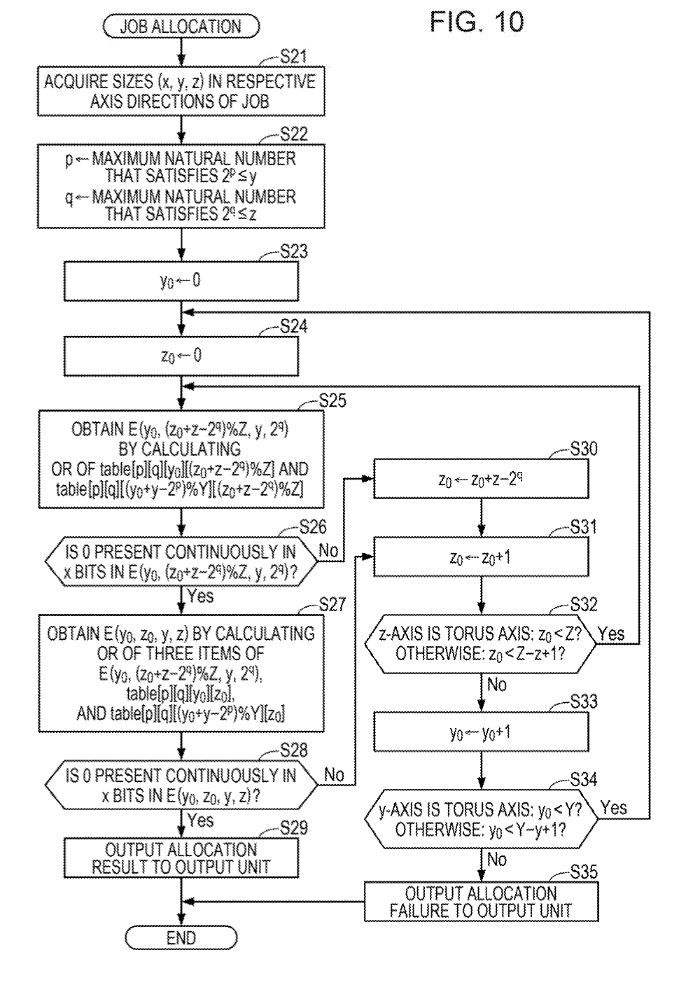

FIG. 10 is a flowchart illustrating an example of job allocation. Hereinafter, the processing illustrated in FIG. 10 is described in the order of step numbers. When the execution node selection unit 140 receives an execution request of a job, the execution node selection unit 140 starts the following procedure.

(S21) The execution node selection unit 140 acquires sizes (x, y, z) in the respective axis directions of the requested job.

(S22) The execution node selection unit 140 substitutes the maximum natural number that satisfies 2^{p}≤y into p, and substitutes the maximum natural number that satisfies 2^{q}≤z into q.

(S23) The execution node selection unit 140 substitutes 0 into y₀.

(S24) The execution node selection unit 140 substitutes 0 into z₀.

(S25) The execution node selection unit 140 obtains a bit string E (y₀, (z₀+z−2^{q})%Z, y, 2^{q}) by calculating OR of a table[p][q][y₀][(z₀+z−^{q})%Z] and a table[p][q][(y₀+y−2^{p})%Y][(z₀+z−2^{q})%Z], where the available node information of a region having the respective axis lengths (c, d) with the starting point (a, b) is expressed by the bit string E (a, b, c, d).

(S26) The execution node selection unit 140 determines whether 0 is present continuously in x bits in the E (y₀, (z₀+z−2^{q})%Z, y, 2^{q}). When 0 is present continuously in x bits, the execution node selection unit 140 proceeds the processing to the step S27. When 0 is not present continuously in x bits, the execution node selection unit 140 proceeds the processing to the step S30.

(S27) The execution node selection unit 140 obtains a bit string E (y₀, z₀, y, z) by calculating OR of three items of the E (y₀, (z₀+z−2^{q})%Z, y, 2^{q}), the table[p][q][y₀][z₀], and the table[p][q][(y₀+y−2^{p})%Y][z₀].

(S28) The execution node selection unit 140 determines whether 0 is present continuously in x bits in the E (y₀, z₀, y, z). When 0 is present continuously in x bits, the execution node selection unit 140 proceeds the processing to the step S29. When 0 is not present continuously in x bits, the execution node selection unit 140 proceeds the processing to the step S31.

(S29) The execution node selection unit 140 outputs an allocation result of the job to the output unit 130. In this case, the x-coordinate at the base point is the coordinate of the start point of the x bits where 0 is continuously present, determined at the step S28, and y- and z-coordinates at the base point is (y₀, z₀). The execution node selection unit 140 may instruct the calculation nodes as allocation nodes of the job to execute the job. The execution node selection unit 140 then ends the processing.

(S30) The execution node selection unit 140 substitutes z₀+z−2^{q} into z₀.

(S31) The execution node selection unit 140 substitutes z₀+1 into z₀.

(S32) The execution node selection unit 140 performs the following determination depending on whether the z-axis is a torus axis or not.

(1) In a case where the z-axis is a torus axis, the execution node selection unit 140 determines whether z₀<Z is established. When z₀<Z is established, the execution node selection unit 140 proceeds the processing to the step S25. When z₀<Z is not established, the execution node selection unit 140 proceeds the processing to the step S33.

(2) In a case where the z-axis is not a torus axis, the execution node selection unit 140 determines whether z₀<Z−z+1 is established. When z₀<Z−z+1 is established, the execution node selection unit 140 proceeds the processing to the step S25. When z₀<Z−z+1 is not established, the execution node selection unit 140 proceeds the processing to the step S33.

(S33) The execution node selection unit 140 substitutes y₀+1 into y₀.

(S34) The execution node selection unit 140 performs the following determination depending on whether the y-axis is a torus axis or not.

(1) In a case where the y-axis is a torus axis, the execution node selection unit 140 determines whether y₀<Y is established. When y₀<Y is established, the execution node selection unit 140 proceeds the processing to the step S24. When y₀<Y is not established, the execution node selection unit 140 proceeds the processing to the step S35.

(2) In a case where the y-axis is not a torus axis, the execution node selection unit 140 determines whether y₀<Y−y+1 is established. when y₀<Y−y+1 is established, the execution node selection unit 140 proceeds the processing to the step S24. When y₀<Y−y+1 is not established, the execution node selection unit 140 proceeds the processing to the step S35.

(S35) The execution node selection unit 140 outputs a job allocation failure to the output unit 130.

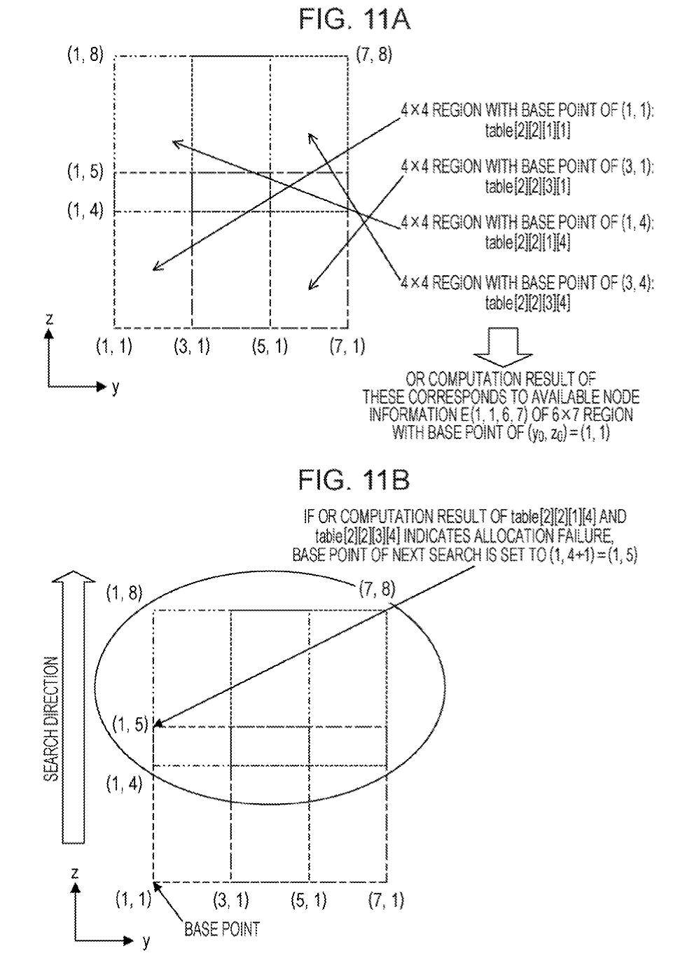

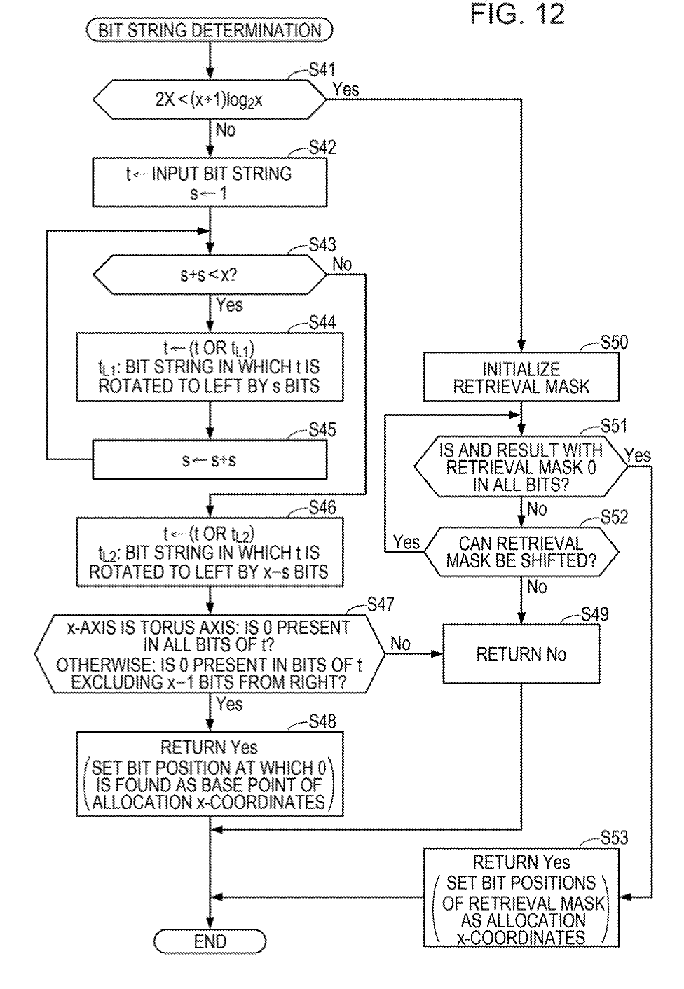

FIGS. 11A and 11B are diagrams each illustrating a search example of an available node. FIG. 11A illustrates an example in which an allocation success/failure is determined within a rectangular parallelepiped having a length 6 in the y-direction and a length 7 in the z-direction, using (y₀, z₀)=(1, 1) as the base point. In this case, the maximum p that satisfies 2^{p}≤6 is 2, and the maximum q that satisfies 2^{q}≤7 is 2. Accordingly, the execution node selection unit 140 uses the following tables (tables of 2²×2²=4×4 region) in which (p, q)=(2, 2) is established to determine the availability of calculation nodes belonging to the region.

A first table is a table[2][2][1][1]. A second table is a table[2][2][3][1]. A third table is a table[2][2][1][4]. A fourth table is a table[2][2][3][4]. An OR computation result of these four tables is equivalent to available node information E (1, 1, 6, 7) of a 6×7 region (bit string) using (y₀, z₀)=(1, 1) as the base point.

In this manner, when available node information for a region with the designated size is not present, the execution node selection unit 140 selects multiple pieces of first available node information for a region having sizes in the y-and z-axes directions smaller the designated sizes in the y- and z-axes directions. Further, the execution node selection unit 140 combines the multiple pieces of first available node information, thereby generates second available node information for a region with the designated sizes in the y- and z-axes directions, and extracts calculation nodes as allocation nodes of the job, based on the second available node information.

FIG. 11B is a diagram for explaining the reason why omission of the search becomes possible by determination at the step S26 in FIG. 10. When an OR computation result of the table[2][2][1][4] and the table[2][2][3][4] among the four tables indicates an allocation failure, the job allocation to a region including a region corresponding to the OR computation result is impossible. Accordingly, at this time, without calculating the E (1, 1, 6, 7), it is understood that the allocation of the job to a region corresponding to the E (1, 1, 6, 7) is impossible. In this case, the execution node selection unit 140 may start the search (search direction is the z-axis direction) of an available calculation node group from a base point (y₀, z₀)=(1, 5) that is ahead by one in the z-direction from (y₀, z₀)=(1, 4).

In this manner, when the execution node selection unit 140 extracts calculation nodes as allocation nodes, the execution node selection unit 140 uses a part of the first available node information among multiple pieces of first available node information, and determines whether the allocation of the job to a region for second available node information is possible. Further, when the allocation is impossible, the execution node selection unit 140 omits the generation of second available node information, and checks the availability of a calculation node group in the next region. In this manner, omitting a part of trials in the determination may further speed up the selection of a calculation node.

Note that, at the steps S26 and S28, the execution node selection unit 140 is able to determine whether 0 is continuously present in the x bits in the bit string at high speed by the following procedure.

FIG. 12 is a flowchart illustrating an example of bit string determination. Hereinafter, the processing illustrated in FIG. 12 is described in the order of step numbers. A procedure indicated below corresponds to the step S26 or the step S28 in FIG. 10.

(S41) The execution node selection unit 140 determines whether 2X<(x+1)log₂x is established. When 2X<(x+1)log₂x is established, the execution node selection unit 140 proceeds the processing to the step S50. When 2X<(x+1)log₂x is not established, the execution node selection unit 140 proceeds the processing to the step S42.

(S42) The execution node selection unit 140 substitutes an input bit string into t, where the input bit string is a bit string E (y₀, (z₀+z−2^{q})%Z, y, 2^{q}) in the case at the step S26, and the input bit string is a bit string E (y₀, z₀, y, z) in the case at the step S28. Further, the execution node selection unit 140 substitutes 1 into s.

(S43) the execution node selection unit 140 determines whether s+s<x is established. When s+s<x is established, the execution node selection unit 140 proceeds the processing to the step S44. When s+s<x is not established, the execution node selection unit 140 proceeds the processing to the step S46.

(S44) The execution node selection unit 140 substitutes a computation result of tORt_{L1} into t, where t_{L1} is a bit string in which t is rotated to the left by s bits.

(S45) The execution node selection unit 140 substitutes s+s into s. The execution node selection unit 140 then proceeds the processing to the step S43.

(S46) The execution node selection unit 140 substitutes a computation result of tORt_{L2} into t, where t_{L2} is a bit string in which t is rotated to the left by x-s bits.

(S47) The execution node selection unit 140 performs the following processing depending on whether the x-axis is a torus axis.

(1) In a case where the x-axis is a torus axis, the execution node selection unit 140 determines whether 0 is present in all the bits of t. When 0 is present, the execution node selection unit 140 proceeds the processing to the step S48. When 0 is not present, the execution node selection unit 140 proceeds the processing to the step S49.

(2) In a cases where the x-axis is not a torus axis, the execution node selection unit 140 determines whether 0 is present in the bits of t excluding the x−1 bits from the right (least significant bit). When 0 is present in the bits, the execution node selection unit 140 proceeds the processing to the step S48. When 0 is not present in the bits, the execution node selection unit 140 proceeds the processing to the step S49.

(S48) The execution node selection unit 140 returns Yes as a determination result. The execution node selection unit 140 sets a bit position at which 0 is found as a base point of the x coordinates (allocation x-coordinates) of allocation nodes. The execution node selection unit 140 then ends the processing.

(S49) The execution node selection unit 140 returns No as a determination result. The execution node selection unit 140 then ends the processing.

(S50) The execution node selection unit 140 initializes a retrieval mask. The retrieval mask is retrieval information for retrieving 0 continuously present in the x bits in a bit string of X bits. The retrieval mask immediately after being initialized is a bit string in which x bits from the most significant bit are set at 1, and other bits are set at 0.

(S51) The execution node selection unit 140 determines whether an AND result of the input bit string and the retrieval mask is 0 in all the bits. When 0 in all the bits is established, the execution node selection unit 140 proceeds the processing to the step S53. When 0 in all the bits is not established, the execution node selection unit 140 proceeds the processing to the step S52.

(S52) The execution node selection unit 140 determines whether the shift (right shift) of the retrieval mask is possible. When the shift is possible, the execution node selection unit 140 shifts the retrieval mask to the right by several bits at once, and proceeds the processing to the step S51. The amount of the right shift is the number obtained by counting the digits within the AND result at the step S51, from a digit at which 1 firstly appears starting from the least significant bit, to the most significant digit in the digits, of in the retrieval mask, where 1 continuously appears. When the shift is impossible, the execution node selection unit 140 proceeds the processing to the step S49. Here, in a case where the x-axis is a torus axis, when the leftmost 1 in the digits where 1 continuously appears in the retrieval mask overflows from the rightmost digit (least significant bit) in the retrieval mask, the shift is impossible, otherwise, the shift is possible. Moreover, in a case where the x-axis is not a torus axis, when the rightmost 1 in the digits where 1 continuously appears in the retrieval mask overflows from the rightmost digit in the retrieval mask, the shift is impossible, otherwise, the shift is possible.

(S53) The execution node selection unit 140 returns Yes as a determination result. The execution node selection unit 140 set bit positions where values of 1 are continuously arranged in the retrieval mask as the allocation x-coordinates. The execution node selection unit 140 then ends the processing.

Here, when 2X<(x+1)log₂x is established in the determination at the step S41, the number of steps for executing the step S50 and the following steps is smaller than that for executing the step S42 and the following steps. In contrast, when 2X<(x+1)log₂x is not established, the number of steps for executing the step S42 and the following steps is smaller than that for executing the step S50 and the following steps. This is because the number of computation steps when the processing is proceeded to the step S50 is approximately 2X/(x+1) at the most, and the number of computation steps when the processing is proceeded to the step S42 is approximately log₂x at the most. In this manner, the execution node selection unit 140 performs the determination at the step S41 in order to select the procedure with the reduced number of computation steps.

Next, a specific example of the processing in the case of No at the step S41 (when the processing is proceeded to the step S42) is described.

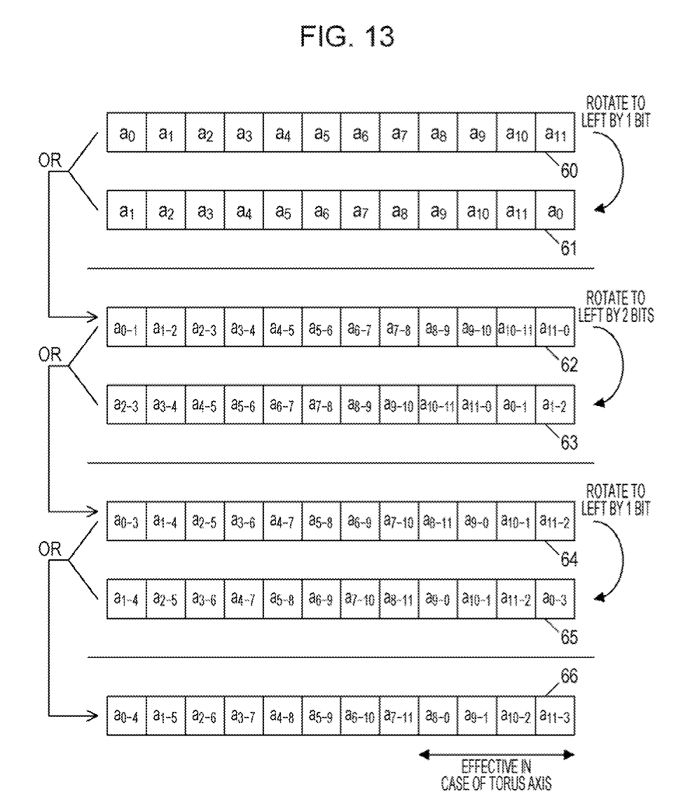

FIG. 13 is a diagram illustrating a specific example of bit string determination. The example herein is an example of obtaining the presence or absence of 0 continuously present in x bits and a start position thereof, by OR computations of [log₂x] times. Here, a case of x=5 and X=12 is exemplified. In FIG. 13, each bit in an input bit string 60 is represented by aₖ. k is an integer of 0 or more corresponding to each digit in the input bit string 60. k=0 is the most significant digit of the input bit string 60. The digit in the input bit string 60 is sequentially lowered as k=1, 2, 3, . . . , and k=11 is the least significant digit of the input bit string 60. Moreover, aₖ₋ₗ indicates a result of OR of all the bits from aₖ to aₗ. In this case, both ends of the bit string are wrapped around. For example, OR of a₀₋₃ is a₀, a₁, a₂, and a₃. OR of a₉₋₁ is a₉, a₁₀, a₁₁, a₀, and a₁.

At the stage immediately before the step S44 is firstly executed, t is the input bit string 60, and s=1. In this case, t_{L1} is a bit string 61. Because of s=1, the bit string 61 is a result obtained by rotating the input bit string 60 to the left by 1 bit. The execution node selection unit 140 substitutes a bit string 62 that is a result of OR computation of the input bit string 60 and the bit string 61 into t (step S44).

The execution node selection unit 140 substitutes s+s=1+1=2 into s (step S45). Because of s+s=2+2=4<5 (Yes at the step S43), the execution node selection unit 140 again executes the step S44. At this stage, t_{L1} is a bit string 63. Because of s=2, the bit string 63 is a result obtained by rotating the bit string 62 to the left by 2 bits. The execution node selection unit 140 substitutes a bit string 64 that is a result of OR computation of the input bit string 62 and the bit string 63 into t (step S44).

The execution node selection unit 140 substitutes s+s=2+2=4 into s (step S45). Because of s+s=4+4=8>5 (No at the step S43), the execution node selection unit 140 proceeds the processing to the step S46. At this stage, t_{L2} is a bit string 65. Because of x−s=5−4=1, the bit string 65 is a result obtained by rotating the bit string 64 to the left by 1 bit. The execution node selection unit 140 substitutes a bit string 66 that is a result of OR computation of the input bit string 64 and the bit string 65 into t (step S46). A bit of 0 present in the bit string 66 obtained in this manner indicates that 0 is present continuously in 5 bits in the input bit string 60. Moreover, it is possible to select the x-coordinate with the digit of 0 as the base point.

Note that, in the bit string 66, bits of a₈₋₀, a₉₋₄, a₁₀₋₂, and a₁₁₋₃ are effective when the x-axis is a torus axis, while are ineffective when the x-axis is not a torus axis. In other words, when the x-axis is a torus axis, coordinates corresponding to the bits of a₈₋₀, a₉₋₁, a₁₀₋₂, and a₁₁₋₃ may become candidates for the base point. In contrast, when the x-axis is not a torus axis, coordinates corresponding to the bits of a₈₋₀, a₉₋₄, a₁₀₋₂, and a₁₁₋₃ may not become candidates for the base point.

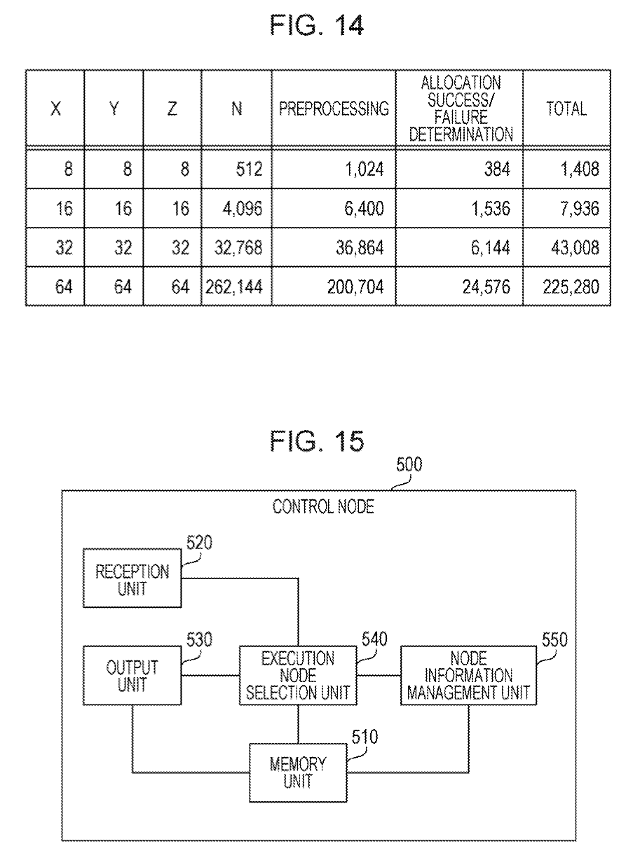

FIG. 14 a diagram illustrating an example of the number of steps desired in relation to the number of calculation nodes. FIG. 14 illustrates the number of steps desired for preprocessing, the number of steps desired for allocation success/failure determination, and the total sum of the two numbers, in association with X, Y, and Z, and the whole number of calculation nodes N (=XYZ). Here, the number of steps desired for the preprocessing is equivalent to the number of executions of the steps S5, S8, and S11 in FIG. 9. Moreover, the number of steps desired for the allocation success/failure determination is equivalent to the number of executions of the steps S44, S46, and S51 in FIG. 12. The number of steps desired will be compared with the number of steps desired in comparative examples of job allocation explained below.

Next, a case where the job allocation is performed by a method different from a job allocation method by the control node 100 is exemplified, and the method is compared with the job allocation method by the control node 100. In the explanation of the comparative examples, a control node 500 is used, instead of the control node 100.

FIG. 15 is a diagram illustrating a comparative example of the function of a control node. The control node 500 includes a memory unit 510, a reception unit 520, an output unit 530, an execution node selection unit 540, and a node information management unit 550.

The reception unit 520 implements the function similar to that of the reception unit 120. The output unit 530 implements the function similar to that of the output unit 130. The node information management unit 550 implements the function similar to that of the node information management unit 150.

Meanwhile, the control node 500 does not have the function equivalent to that of the available node information generation unit 160. Moreover, the execution node selection unit 540 performs the job allocation by a method different from that by the execution node selection unit 140. In the first comparative example, the execution node selection unit 540 performs the job allocation by referring to a bit map (the aforementioned allocation information) in which one bit is associated with the availability of one calculation node. The allocation information is generated by the node information management unit 550, and stored in the memory unit 510. A specific procedure of a first comparative example is as follows.

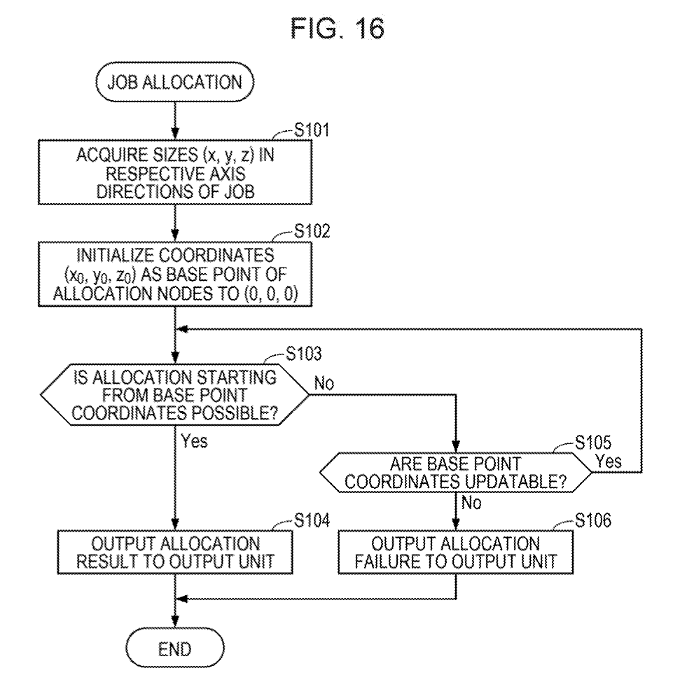

FIG. 16 is a flowchart illustrating the comparative example (first) of job allocation. Hereinafter, the processing illustrated in FIG. 16 is described in the order of step numbers.

(S101) The execution node selection unit 540 acquires sizes (x, y, z) in the respective axis directions of a job.

(S102) The execution node selection unit 540 initializes coordinates (x₀, y₀, z₀) as a base point of allocation nodes to (0, 0, 0).

(S103) The execution node selection unit 540 determines whether the allocation is possible from the base point coordinates. When the allocation is possible, the execution node selection unit 540 proceeds the processing to the step S104. When the allocation is impossible, the execution node selection unit 540 proceeds the processing to the step S105. Here, the detail of the determination method at the step S103 is described later.

(S104) The execution node selection unit 540 outputs an allocation result to the output unit 530. The execution node selection unit 540 then ends the processing.

(S105) The execution node selection unit 540 determines whether the base point coordinates are updatable. When it is updatable, the execution node selection unit 540 updates the base point coordinates, and proceeds the processing to the step S103. When it is not updatable, the execution node selection unit 540 proceeds the processing to the step S106. Here, the detail of the determination method at the step S105 is described later.

(S106) The execution node selection unit 540 outputs the allocation failure to the output unit 530. The execution node selection unit 540 then ends the processing.

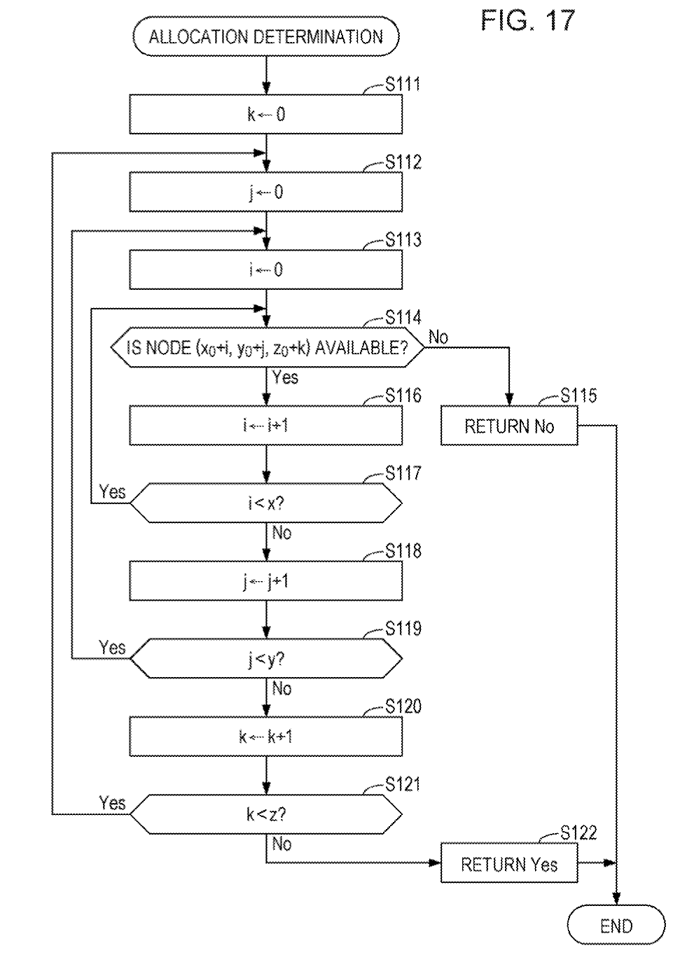

FIG. 17 is a flowchart illustrating the allocation determination in the comparative example (first). Hereinafter, the processing illustrated in FIG. 17 is described in the order of step numbers. A procedure indicated below corresponds to the determination processing at the step S103 in FIG. 16.

(S111) The execution node selection unit 540 substitutes 0 into k.

(S112) The execution node selection unit 540 substitutes 0 into j.

(S113) The execution node selection unit 540 substitutes 0 into i.

(S114) The execution node selection unit 540 determines whether a calculation node at coordinates (x₀+i, y₀+i, z₀+k) is available. When it is available, the execution node selection unit 540 proceeds the processing to the step S116. When it is unavailable, the execution node selection unit 540 proceeds the processing to the step S115.

(S115) The execution node selection unit 540 returns No as a determination result. The execution node selection unit 540 then ends the processing.

(S116) The execution node selection unit 540 substitutes i+1 into i.

(S117) The execution node selection unit 540 determines whether i<x is established. When i<x is established, the execution node selection unit 540 proceeds the processing to the step S114. when i<x is not established, the execution node selection unit 540 proceeds the processing to the step S118.

(S118) The execution node selection unit 540 substitutes j+1 into j.

(S119) The execution node selection unit 540 determines whether j<y is established. When j<y is established, the execution node selection unit 540 proceeds the processing to the step S113. When j<y is not established, the execution node selection unit 540 proceeds the processing to the step S120.

(S120) The execution node selection unit 540 substitutes k+1 into k.

(S121) The execution node selection unit 540 determines whether k<z is established. When k<z is established, the execution node selection unit 540 proceeds the processing to the step S112. When k<z is not established, the execution node selection unit 540 proceeds the processing to the step S122.

(S122) The execution node selection unit 540 returns Yes as a determination result. The execution node selection unit 540 then ends the processing.

Note that, at the step S114, when a torus axis is considered, it may be considered that determination is made as to weather a calculation node at ((x₀+i)%X, (y₀+j)%Y, (z₀+k)%Z) may be available.

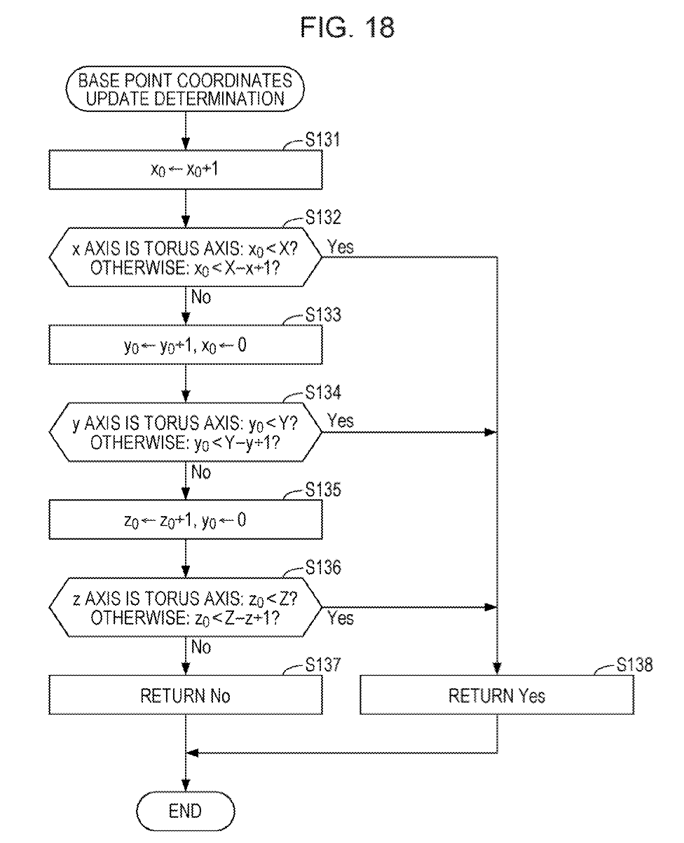

FIG. 18 is a flowchart illustrating base point coordinates update determination in the comparative example (first). Hereinafter, the processing illustrated in FIG. 18 is described in the order of step numbers. A procedure indicated below corresponds to the step S105 in FIG. 16.

(S131) The execution node selection unit 540 substitutes x₀+1 into x₀.

(S132) The execution node selection unit 540 performs the following determination depending on whether the x-axis is a torus axis.

(1) In a case where the x-axis is a torus axis, the execution node selection unit 540 determines whether x₀<X is established. When x₀<X is established, the execution node selection unit 540 proceeds the processing to the step S138. When x₀<X is not established, the execution node selection unit 540 proceeds the processing to the step S133.

(2) In a case where the x-axis is not a torus axis, the execution node selection unit 540 determines whether x₀<X−x+1 is established. When x₀<X−x+1 is established, the execution node selection unit 540 proceeds the processing to the step S138. When x₀<X−x+1 is not established, the execution node selection unit 540 proceeds the processing to the step S133.

(S133) The execution node selection unit 540 substitutes y₀+1 into y₀, and substitutes 0 into x₀.

(S134) The execution node selection unit 540 performs the following determination depending on whether the y-axis is a torus axis.

(1) In a case where the y-axis is a torus axis, the execution node selection unit 540 determines whether y₀<Y is established. When y₀<Y is established, the execution node selection unit 540 proceeds the processing to the step S138. When y₀<Y is not established, the execution node selection unit 540 proceeds the processing to the step S135.

(2) In a case where the y-axis is not a torus axis, the execution node selection unit 540 determines whether y₀<Y−y+1 is established. When y₀<Y−y+1 is established, the execution node selection unit 540 proceeds the processing to the step S138. When y₀<Y−y+1 is not established, the execution node selection unit 540 proceeds the processing to the step S135.

(S135) The execution node selection unit 540 substitutes z₀+1 into z₀, and substitutes 0 into y₀.

(S136) The execution node selection unit 540 performs the following determination depending on whether the z-axis is a torus axis.

(1) In a case where the z-axis is a torus axis, the execution node selection unit 540 determines whether z₀<Z is established. When z₀<Z is established, the execution node selection unit 540 proceeds the processing to the step S138. When z₀<Z is not established, the execution node selection unit 540 proceeds the processing to the step S137.

(2) In a case where the z-axis is not a torus axis, the execution node selection unit 540 determines whether z₀<Z−z+1 is established. When z₀<Z−z+1 is established, the execution node selection unit 540 proceeds the processing to the step S138. When z₀<Z−z+1 is not established, the execution node selection unit 540 proceeds the processing to the step S137.

(S137) The execution node selection unit 540 returns No as a determination result. The execution node selection unit 540 then ends the processing.

(S138) The execution node selection unit 540 returns Yes as a determination result. Note that, the new base point is (x₀, y₀, z₀) at this time. The execution node selection unit 540 then ends the processing.

In this manner, as one example of the job allocation, it may be considered that the execution node selection unit 540 searches for a sub-grid to which a job is to be allocated while one by one checking each of bits corresponding to one calculation node.

In this search, the execution node selection unit 540 may use the aforementioned retrieval mask. Therefore, in a second comparative example, an example is described in which the execution node selection unit 540 performs the job allocation by searching, using the retrieval mask, a bit map in which one bit is associated with the availability of each calculation node.

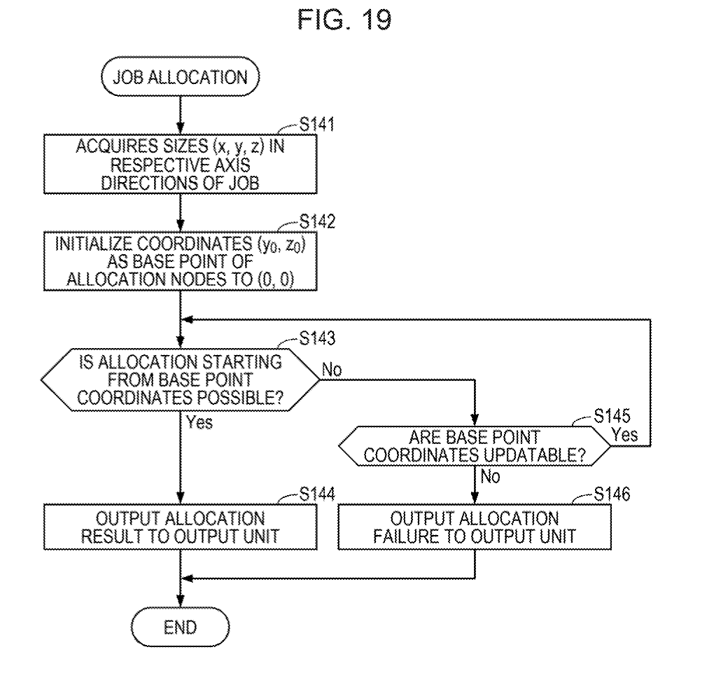

FIG. 19 is a flowchart illustrating the comparative example (second) of job allocation. Hereinafter, the processing illustrated in FIG. 19 is described in the order of step numbers.

(S141) The execution node selection unit 540 acquires sizes (x, y, z) in the respective axis directions of a job.

(S142) The execution node selection unit 540 initializes coordinates (y₀, z₀) as a base point of allocation nodes to (0, 0).

(S143) The execution node selection unit 540 determines whether the allocation is possible from the base point coordinates. When the allocation is possible, the execution node selection unit 540 proceeds the processing to the step S144. When the allocation is impossible, the execution node selection unit 540 proceeds the processing to the step S145. Here, the detail of the determination method at the step S143 is described later.

(S144) The execution node selection unit 540 outputs an allocation result to the output unit 530. The execution node selection unit 540 then ends the processing.

(S145) The execution node selection unit 540 determines whether the base point coordinates are updatable. When it is updatable, the execution node selection unit 540 updates the base point coordinates, and proceeds the processing to the step S143. When it is not updatable, the execution node selection unit 540 proceeds the processing to the step S146. Here, the detail of the determination method at the step S145 is described later.

(S146) The execution node selection unit 540 outputs the allocation failure to the output unit 530. The execution node selection unit 540 then ends the processing.

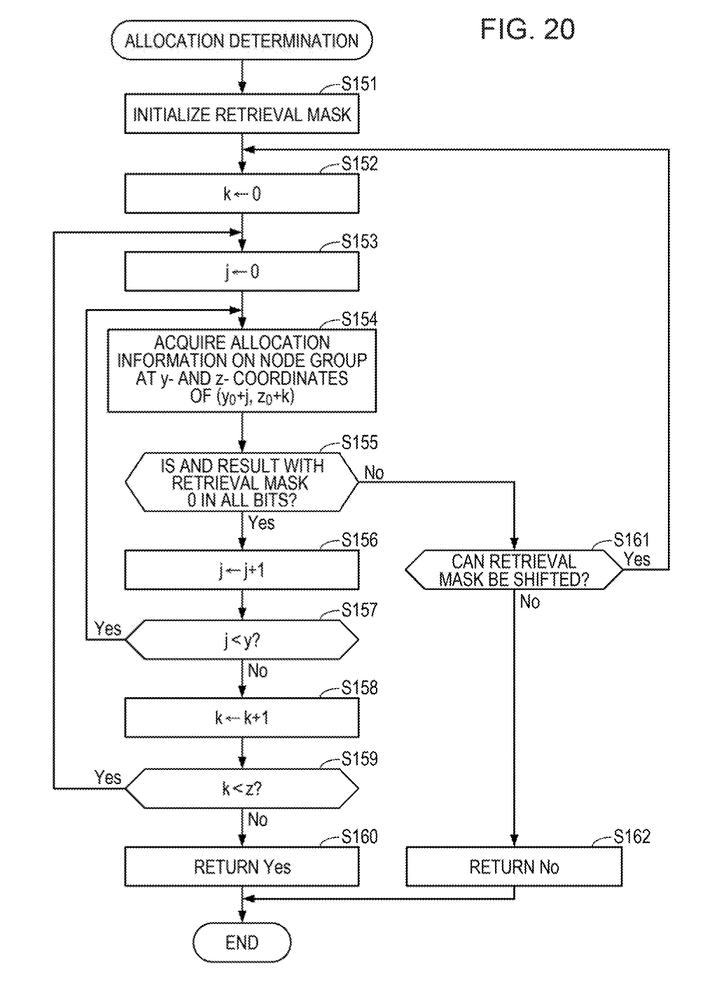

FIG. 20 is a flowchart illustrating the allocation determination in the comparative example (second). Hereinafter, the processing illustrated in FIG. 20 is described in the order of step numbers. A procedure indicated below corresponds to the determination processing at the step S143 in FIG. 19.

(S151) The execution node selection unit 540 initializes a retrieval mask. The initialization method is similar to that at the step S50 in FIG. 12.

(S152) The execution node selection unit 540 substitutes 0 into k.

(S153) The execution node selection unit 540 substitutes 0 into j.

(S154) The execution node selection unit 540 acquires allocation information (bit string) on a node group (calculation node group) at y- and z-coordinates of (y₀+j, z₀+k).

(S155) The execution node selection unit 540 determines whether a result of AND of the bit string acquired at the step S154 with a retrieval mask is 0 in all the bits. When 0 in all the bits is established, the execution node selection unit 540 proceeds the processing to the step S156. When 0 in all the bits is not established, the execution node selection unit 540 proceeds the processing to the step S161.

(S156) The execution node selection unit 540 substitutes j+1 into j.

(S157) The execution node selection unit 540 determines whether j<y is established. When j<y is established, the execution node selection unit 540 proceeds the processing to the step S154. When j<y is not established, the execution node selection unit 540 proceeds the processing to the step S158.

(S158) The execution node selection unit 540 substitutes k+1 into k.

(S159) The execution node selection unit 540 determines whether k<z is established. When k<z is established, the execution node selection unit 540 proceeds the processing to the step S153. When k<z is not established, the execution node selection unit 540 proceeds the processing to the step S160.

(S160) The execution node selection unit 540 returns Yes as a determination result. The execution node selection unit 540 sets the position of the retrieval mask as the allocation x coordinate. The execution node selection unit 540 then ends the processing.

(S161) The execution node selection unit 540 determines whether the retrieval mask may be shifted (shifted to the right). When the shift is possible, the execution node selection unit 540 shifts the retrieval mask to the right by several bits at once, and proceeds the processing to the step S152. The amount of the right shift is the number obtained by counting bits in the AND result at the step S155, from a digit at which 1 firstly appears from the least significant bit, to the most significant digit of the continuous 1 in the retrieval mask. When the shift is impossible, the execution node selection unit 540 proceeds the processing to the step S162.

(S162) The execution node selection unit 540 returns No as a determination result. The execution node selection unit 540 then ends the processing. Note that, at the step S154, when a torus axis is considered, it may be considered that the execution node selection unit 540 acquires allocation information on a calculation node group having the y- and z-coordinates of ((y₀+j)%Y, (z₀+k)%Z).

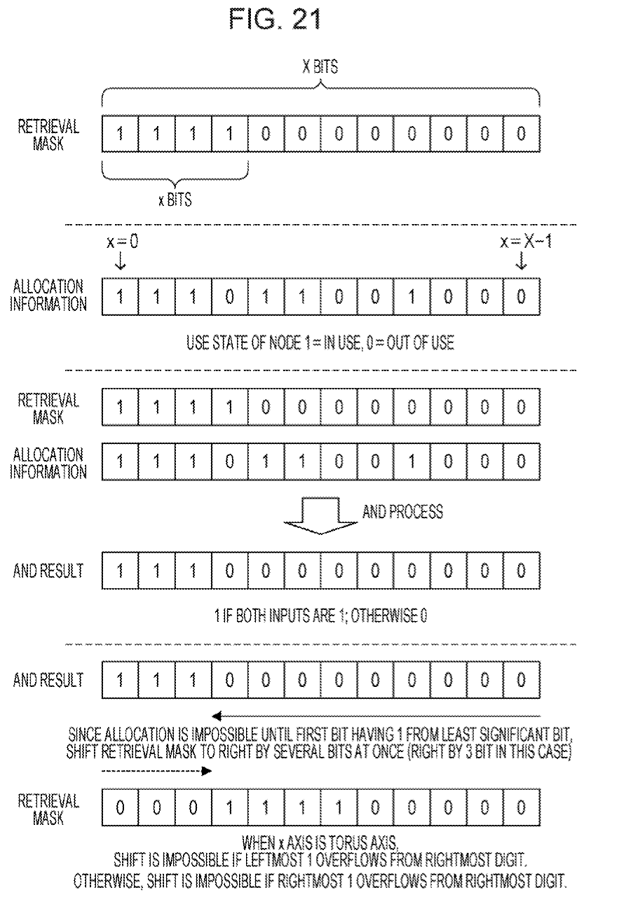

FIG. 21 is a diagram illustrating an example of allocation determination using a retrieval mask. Herein, a case of x=4 and X=12 is exemplified. The retrieval mask immediately after being initialized is 111100000000. Moreover, a bit string for allocation information on (y₀+j, z₀+k) is set to 111011001000. Here, the most significant bit in the bit string is x=0,and the least significant bit is x=X−1. Moreover, as for the use state of a node, 1 indicates that the node is in use, and 0 indicates that the node is out of use.

A result (AND result) of AND processing of the retrieval mask and the allocation information becomes 111000000000 (when both of bits at the same digit are 1, the bit in the AND result at the digit is also 1, otherwise the bit in the AND result at the digit is 0). In this case, since the allocation is impossible until the first bit having 1 from the least significant bit in the bit string 111000000000 of the AND result, the execution node selection unit 540 shifts the retrieval mask to the right by several bits at once (3 bits in this case). As a result, the retrieval mask becomes 000111100000. Further, the execution node selection unit 540 repeats the abovementioned procedure.

Here, as for the shift of the retrieval mask, when the x-axis is a torus axis, the shift is impossible when the leftmost 1 overflows from the rightmost digit of the retrieval mask, and the shift is possible in other cases (right rotate in a case of the torus axis). Moreover, when the x-axis is not a torus axis, the shift is impossible when the rightmost 1 overflows from the rightmost digit of the retrieval mask, and the shift is possible in other cases.

Note that, the example of FIG. 21 may be also grasped as an example of the procedure from the steps S50 to S52 in FIG. 12. When it is grasped as an example of the procedure from the steps S50 to S52 in FIG. 12, the abovementioned “allocation information” may preferably be read as the “input bit string” in the procedure of FIG. 12.

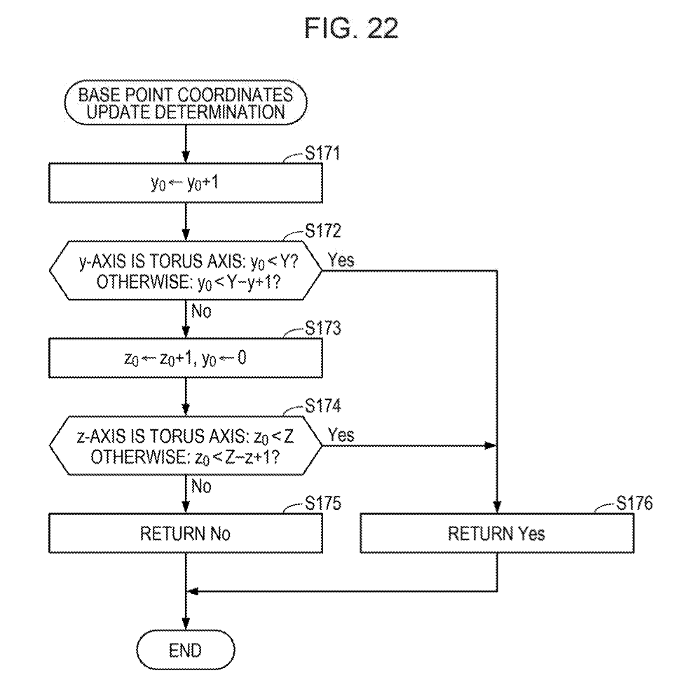

FIG. 22 is a flowchart illustrating base point coordinates update determination in the comparative example (second). Hereinafter, the processing illustrated in FIG. 22 is described in the order of step numbers. A procedure indicated below corresponds to the step S145 in FIG. 19.

(S171) The execution node selection unit 540 substitutes y₀+1 into y₀.

(S172) The execution node selection unit 540 performs the following determination depending on whether the y-axis is a torus axis.

(1) In a case where the y-axis is a torus axis, the execution node selection unit 540 determines whether y₀<Y is established. When y₀<Y is established, the execution node selection unit 540 proceeds the processing to the step S176. When y₀<Y is not established, the execution node selection unit 540 proceeds the processing to the step S173.

(2) In a case where the y-axis is not a torus axis, the execution node selection unit 540 determines whether y₀<Y−y+1 is established. When y₀<Y−y+1 is established, the execution node selection unit 540 proceeds the processing to the step S176. When y₀<Y−y+1 is not established, the execution node selection unit 540 proceeds the processing to the step S173.

(S173) The execution node selection unit 540 substitutes z₀+1into z₀, and substitutes 0 into y₀.

(S174) The execution node selection unit 540 performs the following determination depending on whether the z-axis is a torus axis.

(1) In a case where the z-axis is a torus axis, the execution node selection unit 540 determines whether z₀<Z is established. When z₀<Z is established, the execution node selection unit 540 proceeds the processing to the step S176. When z₀<Z is not established, the execution node selection unit 540 proceeds the processing to the step S175.

(2) In a case where the z-axis is not a torus axis, the execution node selection unit 540 determines whether z₀<Z−z+1 is established. When z₀<Z−z+1 is established, the execution node selection unit 540 proceeds the processing to the step S176. When z₀<Z−z+1 is not established, the execution node selection unit 540 proceeds the processing to the step S175.

(S175) The execution node selection unit 540 returns No as a determination result. The execution node selection unit 540 then ends the processing.

(S176) The execution node selection unit 540 returns Yes as a determination result. Note that, y- and z-coordinates at a new base point are (y₀, z₀) at this time. The execution node selection unit 540 then ends the processing.

In this manner, the execution node selection unit 540 may reduce the number of computation steps by using the retrieval mask, more than that in the first comparative example. However, even if either method in the two comparative examples is used, the increased scale of the parallel processing system 50 results in the increased time for the selection of the calculation nodes so that the degree of the increased time for the selection of the calculation nodes is greater than the degree of the increased number of calculation nodes. The following describes this situation specifically.

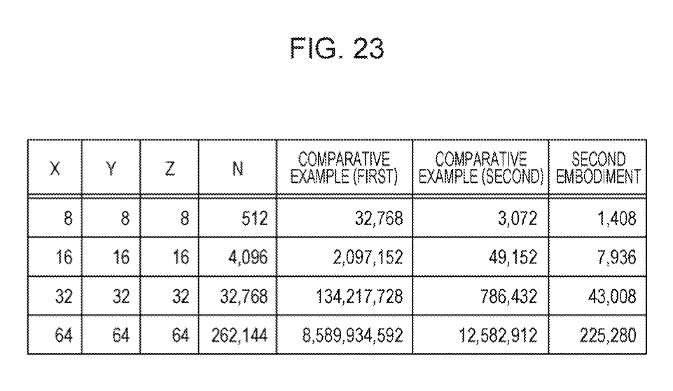

FIG. 23 is a diagram illustrating a comparative example of the number of steps desired in relation to the number of calculation nodes. FIG. 23 illustrates the number of steps desired with the job allocation in the comparative example (first), the comparative example (second), and the second embodiment in association with X, Y, and Z, and the whole number of calculation nodes N (=XYZ).

Here, the number of steps desired in the comparative example (first) is equivalent to the number of executions of the step S114 in FIG. 17, in the procedure of the comparative example (first). The number of steps desired in the comparative example (second) is equivalent to the number of executions of the step S155 in FIG. 20, in the procedure of the comparative example (second). The number of steps desired in the second embodiment is the total of the number of steps desired for the preprocessing and the number of steps desired for the allocation success/failure determination illustrated in FIG. 14.

According to FIG. 23, it may be understood that as the number of calculation nodes increases, the number of steps desired remarkably increases, in the methods in the comparative example (first) and the comparative example (second). Meanwhile, according to the job allocation method by the control node 100 in the second embodiment, an increase in the number of steps desired in relation to an increase in the number of calculation nodes is milder than those in the two comparative examples. Moreover, according to the job allocation method by the control node 100, the number of steps desired is less than those in the two comparative examples, thereby making it possible to select calculation nodes where to allocate the job at high speed. In particular, the job allocation method by the control node 100 is more useful for the more number of calculation nodes.

Moreover, speeding up the node selection when the job is executed may reduce the waiting time for execution of the job, and improve the operating rate of the respective calculation nodes in the parallel processing system 50.

Note that, in the abovementioned example, the control node 100 mainly acquires, for each region having the sizes of a power of 2 in the y- and z-axis directions, available node information on a calculation node group belonging to the region. Meanwhile, the sizes in the y- and z-axis directions of the region may be a power of an integer of 3 or more. The control node 100 may determine, depending on the number of calculation nodes, the size as a power of any integer of 2 or more. For example, it may be considered that as the number of calculation nodes is larger, a power of a larger integer is used, thereby speeding up the selection of a calculation node.

Moreover, in the abovementioned example, although the three-dimensional grid network is mainly exemplified and explained, as described in the foregoing, the respective calculation nodes may be coupled via the two-dimensional or four or more-dimensional grid network.

In addition, the information processing in the first embodiment may be implemented by causing the processing unit 12 to execute a program. Moreover, the information processing in the second embodiment may be implemented by causing the processor 101 to execute a program. The programs may be recorded on the computer-readable recording medium 33.

For example, distributing the recording medium 33 on which a program is recorded makes it possible to distribute the program. Moreover, a program is stored in another computer, and the program may be distributed via a network. The computer may store (install) the program recorded on the recording medium 33 or the program received from another computer in a storage device such as the RAM 102 or the HDD 103, read the program from the storage device, and execute the read program, for example.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory, computer-readable recording medium having stored therein a program for causing a computer to execute a process to allocate a job to a plurality of nodes in a parallel processing system in which the plurality of nodes are coupled to each other via a mesh connection or a torus connection, the process comprising:
at start and end of execution of the job, for each of regions in an n -dimensional space representing a connection relation among the plurality of the nodes, generating available node information indicating whether each of a group of nodes corresponding the region is available for execution of the job, where n is an integer of 2 or more, and a size in a direction of each axis in the n-dimensional space other than a predetermined axis is a power of a predetermined integer of 2 or more; and
upon reception of an execution request of the job including a designated size in a direction of each axis, selecting the available node information in accordance with the designated size, and determining a target node to which the job is to be allocated, based on the selected available node information.

2. The non-transitory, computer-readable recording medium of claim 1, wherein
the available node information is configured as a bit string including a plurality of bits each corresponding to a coordinate value on the predetermined axis, and
in the generating of the available node information, a first bit corresponding to a first coordinate value of the predetermined axis in the region is set at a first value when allocation of the job is possible to all nodes belonging to a portion corresponding to the first coordinate value, and set at a second value when allocation of the job is impossible to at least one of the nodes belonging to the portion.

3. The non-transitory, computer-readable recording medium of claim 2, wherein
the determining the target node includes:
determining whether the bit string includes a sub-string of bits whose number is equal to the designated size of the predetermined axis direction and in which the first value is continuously set, and
when the bit string includes the sub-string of bits, determining, as the target node of the job, a node that is included in the group of nodes associated with the region, and corresponds to coordinate values of the sub-string of bits.

4. The non-transitory, computer-readable recording medium of claim 1, wherein
the selecting the available node information includes selecting plural pieces of first available node information each associated with a region whose size in a direction of each axis other than the predetermined axis is smaller than the designated size for the direction of the axis; and
the determining the target node includes:
generating second available node information for the region having the designated size in a direction of each axis other than the predetermined axis by combining the plural pieces of first available node information, and
determining the target node of the job, based on the second available node information.

5. The non-transitory, computer-readable recording medium of claim 4, wherein
the determining the target node includes :
determining whether allocation of the job to the region associated with the second available node information is possible, by using a portion of the first available node information, and
when the allocation is impossible, omitting the generation of the second available node information.

6. An apparatus comprising:
a plurality of nodes coupled to each other via a mesh connection or a torus connection, each of the plurality of nodes including a first processor; and
a second processor configured to:
execute a process to allocate a job to the plurality of nodes, the process including:
at start and end of execution of the job, for each of regions in an n-dimensional space representing a connection relation among the plurality of the nodes, generating available node information indicating whether each of a group of nodes corresponding the region is available for execution of the job, where n is an integer of 2 or more, and a size in a direction of each axis in the n-dimensional space other than a predetermined axis is a power of a predetermined integer of 2 or more, and
upon reception of an execution request of the job including a designated size in a direction of each axis, selecting the available node information in accordance with the designated size, and determining a target node to which the job is to be allocated, based on the selected available node information.

7. A method to allocate a job to a plurality of nodes in a parallel processing system in which the plurality of nodes are coupled to each other via a mesh connection or a torus connection, the method comprising:
at start and end of execution of the job, for each of regions in an n-dimensional space representing a connection relation among the plurality of the nodes, generating available node information indicating whether each of a group of nodes corresponding the region is available for execution of the job, where n is an integer of 2 or more, and a size in a direction of each axis in the n-dimensional space other than a predetermined axis is a power of a predetermined integer of 2 or more; and
upon reception of an execution request of the job including a designated size in a direction of each axis, selecting the available node information in accordance with the designated size, and determining a target node to which the job is to be allocated, based on the selected available node information.
